(19) United States
(12) Patent Application Publication
(10) Pub. No.: US 2024/0087561 A1
(43) Pub. Date: Mar. 14, 2024

(54) USING SCENE-AWARE CONTEXT FOR CONVERSATIONAL AI SYSTEMS AND APPLICATIONS

(71) Applicant: NVIDIA Corporation, Santa Clara, CA (US)

(72) Inventors: Niral Lalit Pathak, San Jose, CA (US); Rajath Shetty, Sunnyvale, CA (US); Ratin Kumar, Cupertino, CA (US)

(21) Appl. No.: 17/942,950

(22) Filed: Sep. 12, 2022

(51) Int. Cl. G10L 15/18; G06F 3/01; G06T 7/73; G10L 15/16; G10L 15/183

(52) U.S. Cl. CPC G10L 15/1822; G06F 3/013; G06F 3/017; G06T 7/73; G10L 15/16; G10L 15/183; G06T 2207/20081

(57) ABSTRACT

In various examples, techniques for using scene-aware context for dialogue systems and applications are described herein. For instance, systems and methods are disclosed that process audio data representing speech in order to determine an intent associated with the speech. Systems and methods are also disclosed that process sensor data representing at least a user in order to determine a point of interest associated with the user. In some examples, the point of interest may include a landmark, a person, and/or any other object within an environment. The systems and methods may then generate a context associated with the point of interest. Additionally, the systems and methods may process the intent and the context using one or more language models. Based on the processing, the language model(s) may output data associated with the speech.

### BACKGROUND

Vehicles may be equipped with dialogue systems that allow passengers to perform various tasks, such as control one or more operations of the vehicles (e.g., lock/unlock doors, lock/unlock windows, turn on/off radios, etc.), provide information about landmarks (e.g., provide information about buildings, bridges, waterways, etc.), plan activities (e.g., making reservations, etc.), schedule travel plans (e.g., booking arrangements for transportation and accommodations etc.), shop for items (e.g., purchase items from online marketplaces, etc.), and/or so forth. Some dialogue systems operate by receiving text—such as text including one or more letters, words, numbers, and/or symbols—that is generated as a transcript of spoken language (e.g., a user utterance). In some circumstances, the text may indicate a request to perform a task, such as to determine information associated with a landmark. The dialogue systems then process the text using a large language model that is configured to output data associated with the request.

However, in some circumstances, the dialogue systems may have difficulty determining a context associated with the spoken language. For instance, if a user is requesting information about a landmark located within the environment, the user needs to identify the landmark as part of the spoken language in order for the dialogue systems to provide adequate feedback to the user. For example, if the user is requesting information about “Farmer's Restaurant” (e.g., the landmark), the spoken language may include “Please provide information about Farmer's Restaurant.” If the user does not provide this context, then the dialogue systems may proceed to ask the user one or more questions in order to determine the context. For example, if the spoken language includes “Please provide information about that restaurant,” then the dialogue systems may respond with a question, such as “What restaurant.” The user may then need to provide the additional context, such as with additional spoken language that includes “Farmer's Restaurant.” This may become cumbersome for the user, as the user may need to provide multiple utterances before the dialogue systems provide the requested information.

### SUMMARY

Embodiments of the present disclosure relate to using scene-aware context for dialogue systems and applications. Systems and methods are disclosed that may receive audio data representing speech from a user. The systems and methods may also use sensor data generated by one or more sensors and/or map data to identify a context associated with the speech. In some examples, the systems and methods determine the context by analyzing the sensor data and/or the map data using one or more gaze recognition and/or gesture recognition techniques. For example, the systems and methods may use a gaze recognition technique(s) and/or a gesture recognition technique(s) to determine a point of interest (POI) of the user, where the context is associated with the POI. The systems and methods may then input text data associated with the audio data and context data representing the context into one or more language models that are configured to output data related to the audio data. For example, if the audio data represents a request for information about a landmark and the context includes an identifier associated with the landmark that was identified using the POI, then the language model(s) may output data that represents the information.

In contrast to conventional systems, such as those described above, the current systems input additional context data that the language model(s) is able to use when generating the output associated with the speech. For example, the conventional systems may receive audio data from a user that represents a request for information about a landmark, such as a bridge. However, if the audio data does not also represent information associated with the landmark, such as an identifier (e.g., a name) of the landmark, then the conventional systems are not able to determine the requested information without receiving additional information from the user. In contrast, the current systems are able to use multi-modal information in order to determine a context associated with the speech. More specifically, the current systems may use one or more sensors to identify the landmark within the environment, such as based on a gaze and/or gesture of the user (e.g., the POI of the user). The current systems are then able to use this additional context, along with the audio data, to determine the requested information.

### BRIEF DESCRIPTION OF THE DRAWINGS

The present systems and methods for using scene-aware context for dialogue systems and applications are described in detail below with reference to the attached drawing figures, wherein:

FIG. 1 illustrates an example of using scene-aware context for dialogue systems, in accordance with some embodiments of the present disclosure;

FIG. 2 illustrates an example of a speech model(s) processing audio data to determine an intent and information associated with slots, in accordance with some embodiments of the present disclosure;

FIG. 3 is an example process for determining a point of interest (POI) using gaze estimation, in accordance with some embodiments of the present disclosure;

FIG. 4A depicts an example plot generated using eye movement information, in accordance with some embodiments of the present disclosure;

FIGS. 4B-4C depict example illustrations of eye locations at a time step or frame used for determining eye movement information, in accordance with some embodiments of the present disclosure;

FIG. 5A depicts an example visualization of a gaze direction representation extended exterior to a vehicle for determining a POI, in accordance with some embodiments of the present disclosure;

FIG. 5B depicts a top-down view of a vehicle localized on a map, in accordance with some embodiments of the present disclosure;

FIG. 6 is an example process for determining a POI using gesture estimation, in accordance with some embodiments of the present disclosure;

FIG. 7 depicts an example visualization of a gesture direction representation extended exterior to a vehicle for determining a POI, in accordance with some embodiments of the present disclosure;

FIG. 8 depicts an example of providing content to a user, in accordance with some embodiments of the present disclosure;

FIG. 9 depicts an example of identifying a user associated with audio data, in accordance with some embodiments of the present disclosure;

FIG. 10 is a flow diagram showing a method for using scene-aware context for dialogue systems, in accordance with some embodiments of the present disclosure;

FIG. 11 is a flow diagram showing a method for identifying a user associated with audio data, in accordance with some embodiments of the present disclosure;

FIG. 12A is an illustration of an example autonomous vehicle, in accordance with some embodiments of the present disclosure;

FIG. 12B is an example of camera locations and fields of view for the example autonomous vehicle of FIG. 12A, in accordance with some embodiments of the present disclosure;

FIG. 12C is a block diagram of an example system architecture for the example autonomous vehicle of FIG. 12A, in accordance with some embodiments of the present disclosure;

FIG. 12D is a system diagram for communication between cloud-based server(s) and the example autonomous vehicle of FIG. 12A, in accordance with some embodiments of the present disclosure;

FIG. 13 is a block diagram of an example computing device suitable for use in implementing some embodiments of the present disclosure; and

FIG. 14 is a block diagram of an example data center suitable for use in implementing some embodiments of the present disclosure.

### DETAILED DESCRIPTION

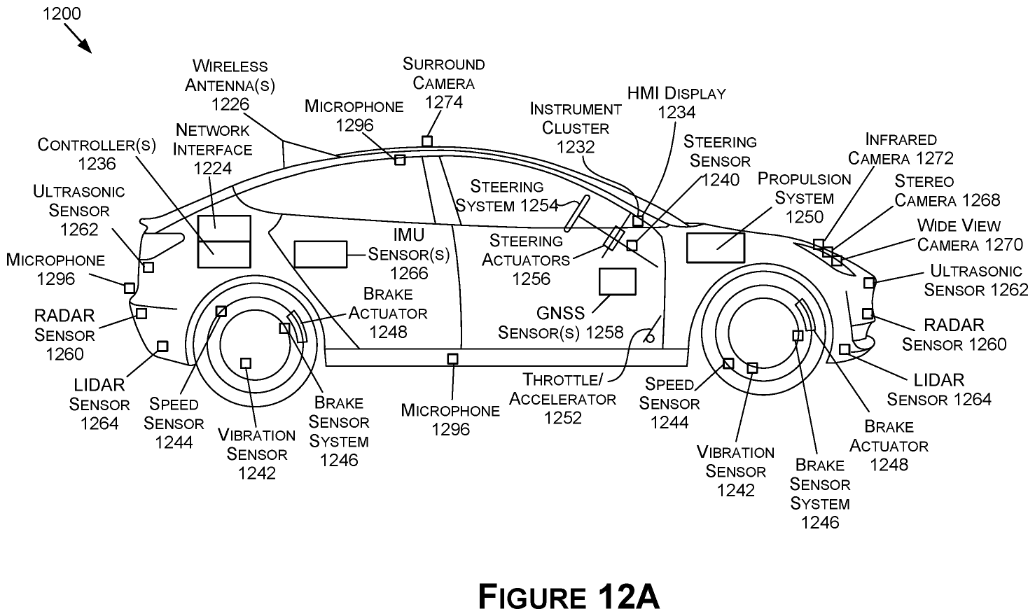

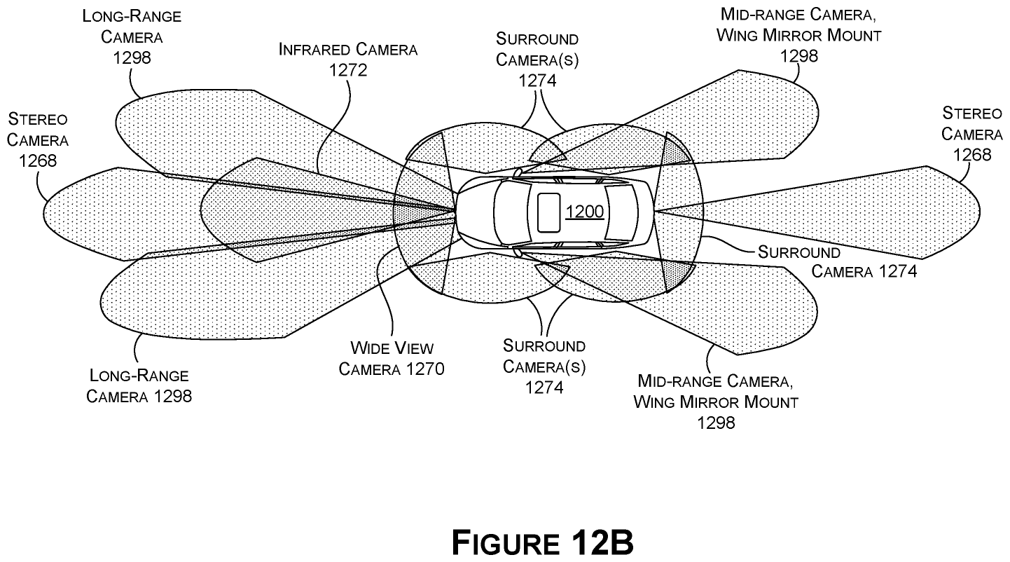

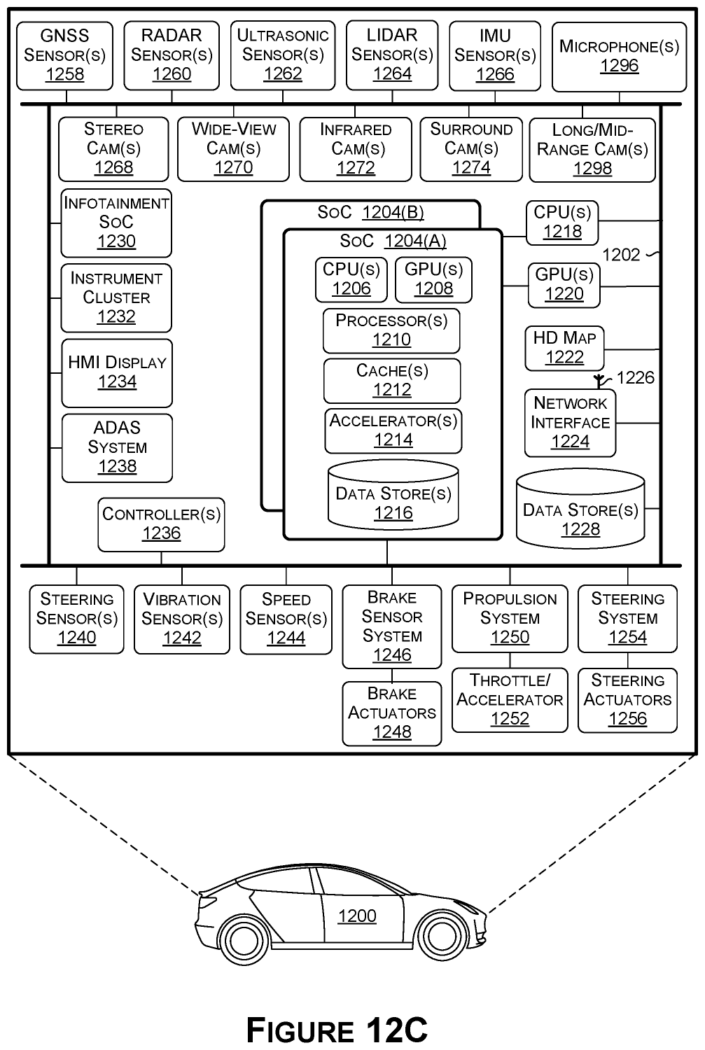

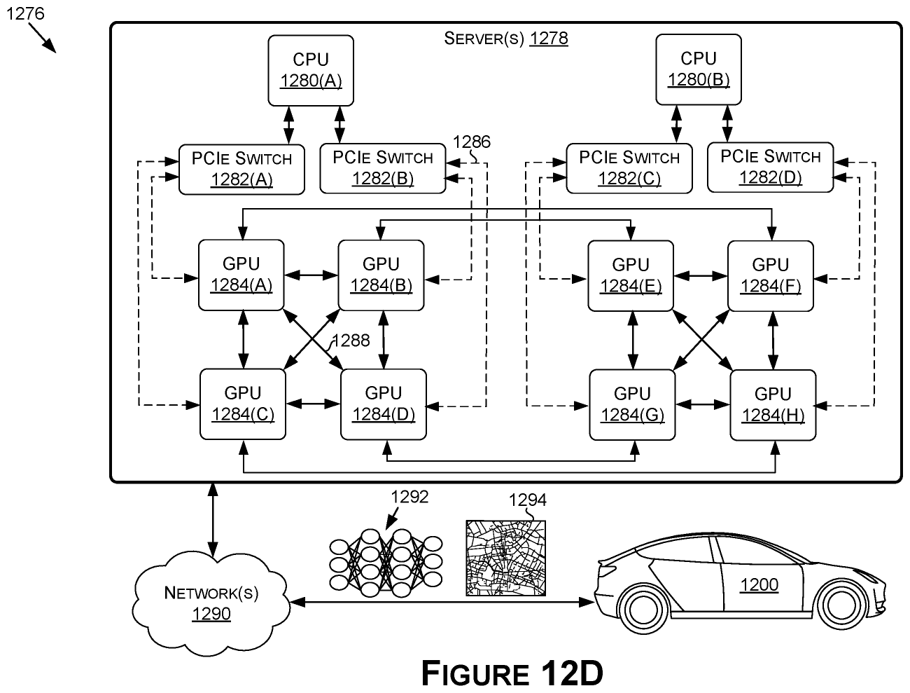

Systems and methods are disclosed related to using scene-aware context for dialogue systems and applications. Although the present disclosure may be described with respect to an example autonomous vehicle 1200 (alternatively referred to herein as “vehicle 1200” or “ego-vehicle 1200,” an example of which is described with respect to FIGS. 12A-12D), this is not intended to be limiting. For example, the systems and methods described herein may be used by, without limitation, non-autonomous vehicles, semi-autonomous vehicles (e.g., in one or more adaptive driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. In addition, although the present disclosure may be described with respect to dialogue systems within vehicles, this is not intended to be limiting, and the systems and methods described herein may be used in augmented reality, virtual reality, mixed reality, robotics, security and surveillance, autonomous or semi-autonomous machine applications, and/or any other technology spaces where dialogue systems may be used.

For instance, a system(s) may receive audio data generated by one or more microphone(s) within a vehicle, where the audio data represents speech (e.g., an utterance) from a user of the vehicle. In some examples, the speech may be associated with a task being requested by the user, such as a request to provide information associated with a landmark located within an environment and proximate to the vehicle. The system(s) may then process the audio data using one or more first models, such as one or more speech models (e.g., an automatic speech recognition (ASR) model(s), a speech to text (STT) model(s), a natural language processing (NLP) model(s), etc.), that are configured to determine an intent associated with the speech. As described herein, an intent may include, but is not limited to, requesting information (e.g., information about a landmark, information about a location, information about a person, etc.), booking a reservation (e.g., booking a hotel, booking a dinner reservation, booking an event ticket, etc.), scheduling an event (e.g., scheduling a birthday party, scheduling a sporting match, etc.), starting a communication (making a phone call, starting a video conference, etc.), creating a list (e.g., creating a shopping list, creating a to-do list, etc.), acquiring an item and/or service, and/or any other intent.

In some examples, the first model(s) may further be configured to determine information for one or more slots associated with the intent. As described herein, a slot may provide additional information (e.g., a parameter) for performing the intent. For example, if the speech is associated with an utterance that includes “Can you provide information about that glass building,” then the intent may include “requesting information” and the slots may include “glass” and “building.”

The system(s) may further use one or more sensors of the vehicle to determine a context associated with the speech. For instance, sensor(s) of the vehicle may be used to generate sensor data for tracking the user's movements, such as eye movements, head movements, hand gestures, and/or the like. This information may be used by the system(s) to determine the attentiveness of the user, a gaze direction of the user, and/or meaningful gestures of the user (e.g., the user pointing at a landmark). In some examples, the system(s) may use this information to project a virtual representation of the user (e.g., the user's gaze direction, the user's gesture direction, etc.) to a point or region that is exterior to the vehicle. For a first example, one or more gaze components may use sensor data from the sensor(s) to determine the user's gaze direction relative to the vehicle. For a second example, one or more gesture components may use sensor data from the sensor(s) to determine the user's gesture direction relative to the vehicle.

Using the location of the vehicle within a map(s) of the environment, the system(s) may map (e.g., in real-time or near real-time) the user's gaze direction and/or the user's gesture direction to the map(s) in order to determine a point of interest (POI) that the user is focusing on (e.g., that the user is looking at, that the user is pointing at, etc.). As described herein, a POI may include, but is not limited to, a landmark (e.g., a building, a waterway, a bridge, a statue, etc.), a location, a sign, a person, and/or the like located within the environment. In some examples, the system(s) may map the user's gaze direction and/or the user's gesture direction to a respective POI for two or more (e.g., each) of the maps. For example, the system(s) may map the user's gaze direction and/or the user's gesture direction to a first POI using a first map and a second POI using a second map. In such examples, the system(s) may perform one or more processes to select one of the POIs.

For a first example, the system(s) may determine a first confidence associated with the first POI and a second confidence associated with the second POI. The system(s) may then select the POI that is associated with the highest confidence (e.g., select the first POI if the first confidence is higher than the second confidence). For a second example, the system(s) may receive additional sensor data generated by one or more exterior sensors of the vehicle, where the additional sensor data represents the environment. The system(s) may then use this sensor data to select one of the POIs. For instance, if the sensor data represents an image that depicts the first ROI, then the system(s) may use the sensor data to select the first ROI.

The system(s) may then determine the context associated with the intent based on the POI, where the context may represent additional information associated with the intent. For a first example, if the POI is a landmark, then the context may include an identifier (e.g., a name, a nickname, etc.) associated with the landmark, an attribute (e.g., a color, a size, a shape, etc.) of the landmark, and/or any other information associated with the landmark. For a second example, if the POI is a person, then the context may include an identifier (e.g., a name, a nickname, etc.) associated with the person. While these are just a couple example types of contexts associated with an intent, in other examples, a context may include additional and/or alternative information associated with the intent.

The system(s) may then input data (e.g., a first vector(s)) representing the intent, data (e.g., a second vector(s)) representing the information for the slot(s), and data (e.g., a third vector(s)) representing the context into one or more language models. As described herein, the language model(s) may include any type of language model(s), such as a generative language model(s) (e.g., a Generative Pretrained Transformer (GPT), etc.), a representation language model(s) (e.g., a Bidirectional Encoder Representations from Transformers (BERT), etc.), and/or any other type of language model. The language model(s) may be trained to process the intent, the information associated with the slot(s), and/or the context. Based on the processing, the language model(s) may output data associated with the intent. For example, if the intent includes “requesting information,” the slot includes “structure,” and the context includes an identifier (e.g., a name) of the structure, then the language model(s) may output data representing information associated with the structure.

In some examples, the output may include audio data representing one or more words describing the information. For instance, and using the example above, the audio data may represent words describing the name of the structure, the date the structure was built, and/or any other information. In some examples, one or more components of the vehicle may use the output from the language model(s) to generate a different type of output for the user. For example, the component(s) of the vehicle may use the output from the language model(s) to generate image data representing one or more images that include the information associated with the structure. In either example, the vehicle may then provide the output to the user. For example, the vehicle may output sound represented by the audio data using one or more speakers, display the image(s) represented by the image data using one or more displays, and/or the like.

In some examples, the user may continue to interact with the language model(s). For example, vehicle may generate additional audio data representing additional speech, such as an additional utterance, from the user. The vehicle may then perform the processes described herein to process the additional audio data and determine an additional intent and/or additional information associated with an additional slot(s). In some examples, the vehicle may perform the processes described herein to determine an additional context associated with the additional speech. The vehicle may then process the additional intent, the additional information associated with the additional slot(s), and/or the additional context using the language model(s). Based on the processing, the language model(s) may continue to output data associated with the additional speech.

The systems and methods described herein may be used by, without limitation, non-autonomous vehicles, semi-autonomous vehicles (e.g., in one or more adaptive driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, speech recognition, autonomous or semi-autonomous machine applications, deep learning, environment simulation, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, speech recognition, systems implemented using an edge device, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems implemented at least partially using cloud computing resources, and/or other types of systems.

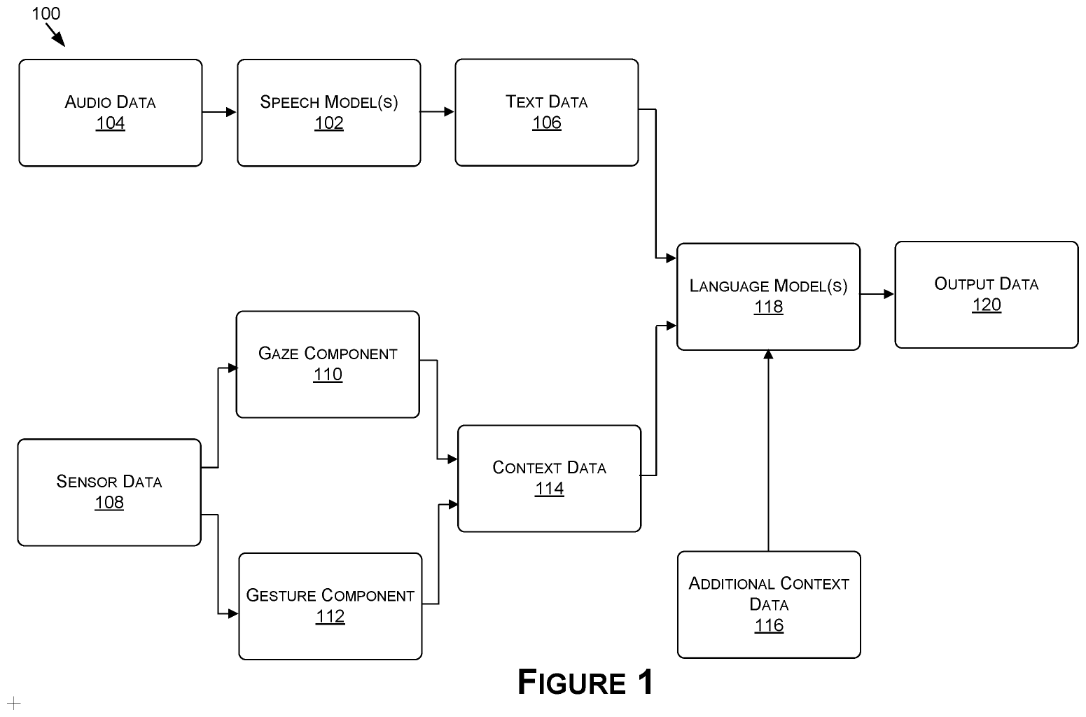

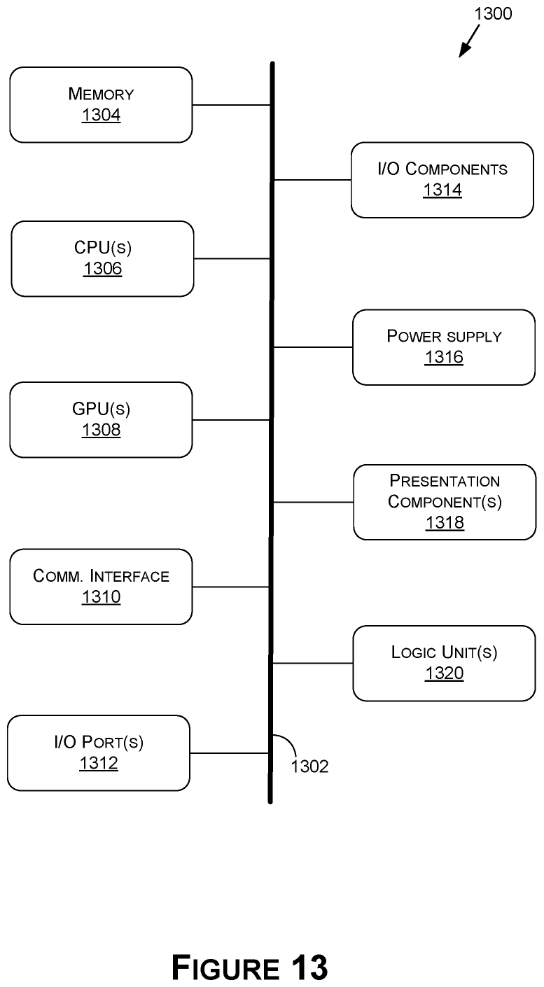

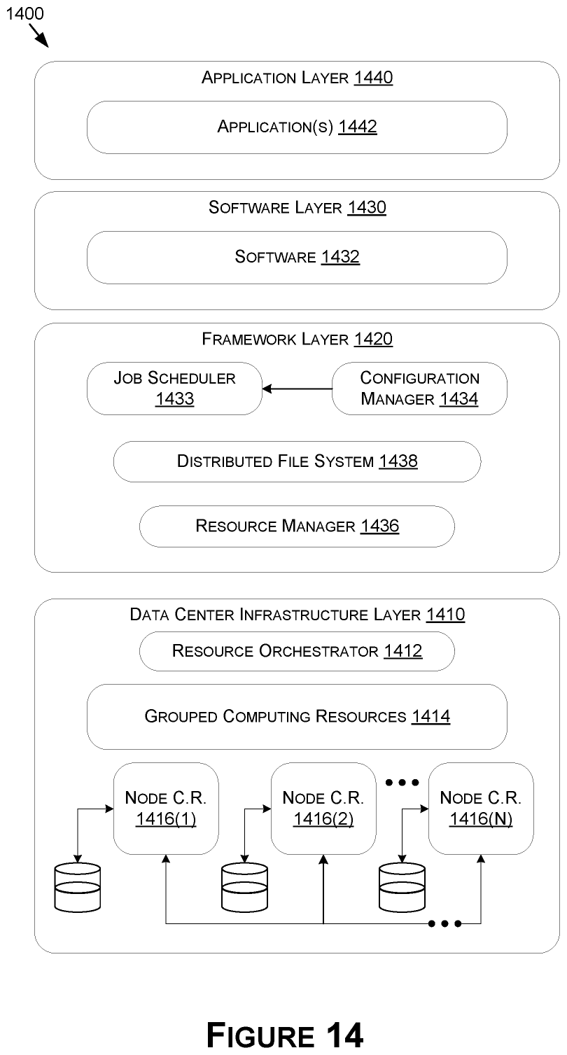

With reference to FIG. 1, FIG. 1 is an example of using scene-aware context with dialogue systems, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionality to those of example autonomous vehicle 1200 of FIGS. 12A-12D, example computing device 1300 of FIG. 13, and/or example data center 1400 of FIG. 14.

The process 100 may include one or more speech models 102 processing audio data 104. For instance, the vehicle may generate the audio data 104 using one or more microphone(s), where the audio data 104 represents speech (e.g., an utterance) from a user of the vehicle. In some examples, the speech may represent a task being requested by the user, such as a request to provide information associated with a POI located within an environment and proximate to the vehicle. The vehicle may then process the audio data 104 using the speech model(s) 102. As described herein, the speech model(s) 102 may include, but is not limited to, one or more ASR models, one or more STT models, one or more NLP models, and/or any other type of speech model. Based on processing the audio data 104, the speech model(s) 102 may be configured to determine an intent associated with the speech. The intent may include, but is not limited to, requesting information (e.g., information about a landmark, information about a location, information about a person, etc.), booking a reservation (e.g., booking a hotel, booking a dinner reservation, booking an event ticket, etc.), scheduling an event (e.g., scheduling a birthday party, scheduling a sporting match, etc.), starting a communication (making a phone call, starting a video conference, etc.), creating a list (e.g., creating a shopping list, creating a to-do list, etc.), acquiring an item and/or service, and/or any other intent.

In some examples, the speech model(s) 102 may further be configured to determine information for one or more slots associated with the intent. As described herein, a slot may provide additional information (e.g., a parameter) for performing the intent. For a first example, if the speech is associated with an utterance that includes “Can you provide information about that glass building,” then the intent may include “requesting information” and the slots may include “glass” and “building.” For a second example, if the speech is associated with an utterance that includes “Can you make a reservation at that restaurant today,” then the intent may include “booking a reservation” and the slots may include “restaurant” and “today.”

In some examples, the vehicle may generate the audio data 104 and/or process the audio data 104 using the speech model(s) 102 based on the occurrence of one or more events. For a first example, the vehicle may generate the audio data 104 and/or process the audio data 104 using the speech model(s) 102 based on a user providing input (e.g., pressing) a device, such as a button, located within the vehicle. For a second example, the vehicle may generate the audio data 104 and/or process the audio data 104 using the speech model(s) 102 based on determining that previous audio data represents a specific word(s), such as a trigger word. For a third example, the vehicle may generate the audio data 104 and/or process the audio data 104 using the speech model(s) 102 based on determining that the user is focusing on one or more components of the vehicle (e.g., using one or more of the processes described herein), such as a dash and/or a display. While these are just a couple example events that may cause the vehicle to generate and/or process the audio data 104, in other examples, the vehicle may generate and/or process the audio data 104 based on detected one or more additional and/or alternative events.

As show by the example of FIG. 1, the speech model(s) 102 may output text data 106 associated with the audio data 104. In some examples, the text data 106 may represent the intent associated with the audio data 104. For instance, if the intent includes “requesting information,” then the text data 106 may include one or more vectors that represent the words “requesting” and “information.” In some examples, the text data 106 may represent information for one or more slots associated with the intent. For instance, if the slots associated with the intent include “building” and “glass,” then the text data 106 may include one or more vectors that represent the words “building” and “glass.”

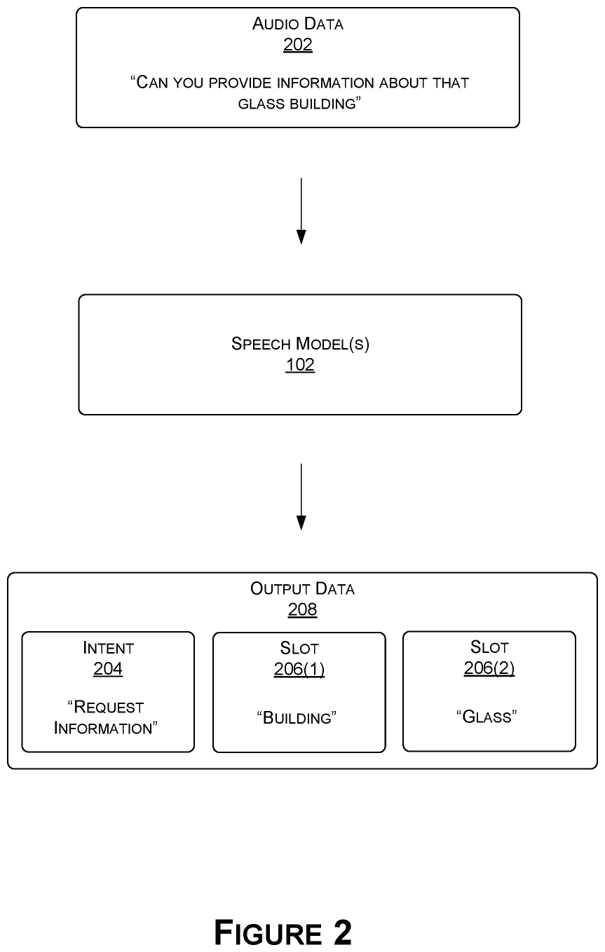

For instance, FIG. 2 illustrates an example of the speech model(s) 102 processing audio data 202 (which may represent, and/or include, the audio data 104) to determine an intent 204 and information associated with slots 206(1)-(2) (also referred to singularly as “slot 206” or in plural as “slots 206”), in accordance with some embodiments of the present disclosure. As shown, the audio data 202 may represent speech (e.g., an utterance) that includes “Can you provide information about that glass building.” As such, the speech model(s) 102 may process the audio data 202 and generate output data 208 (which may represent, and/or include, the text data 106). As shown, the speech model(s) 102 may determine that the intent 204 includes “request information.” The speech model(s) 102 may further determine that information for a first slot 206(1) includes “building” and information for a second slot 206(2) includes “glass.” While the example of FIG. 2 illustrates the speech model(s) 102 determining two slots 206 associated with the intent 204, in other examples, the speech model(s) 102 may determine any number of slots 206 associated with the intent 204 (e.g., zero slots, one slot, five slots, ten slots, etc.).

Referring back to the example of FIG. 1, the process 100 may include the vehicle generating sensor data 108 using one or more sensors. In some examples, the sensor data 108 may include image data generated by one or more interior cameras of the vehicle, where the image data represents one or more images depicting at least the user that provided the speech. For instance, the image(s) may depict at least the head, the eyes, the hand, and/or the like of the user. In some examples, the sensor data 108 may include image data generated by one or more exterior cameras of the vehicle, where the image data represents one or more images depicting an environment for which the vehicle is navigating. In either example, the process 100 may then include using a gaze component 110 and/or a gesture component 112 to determine a POI associated with the user.

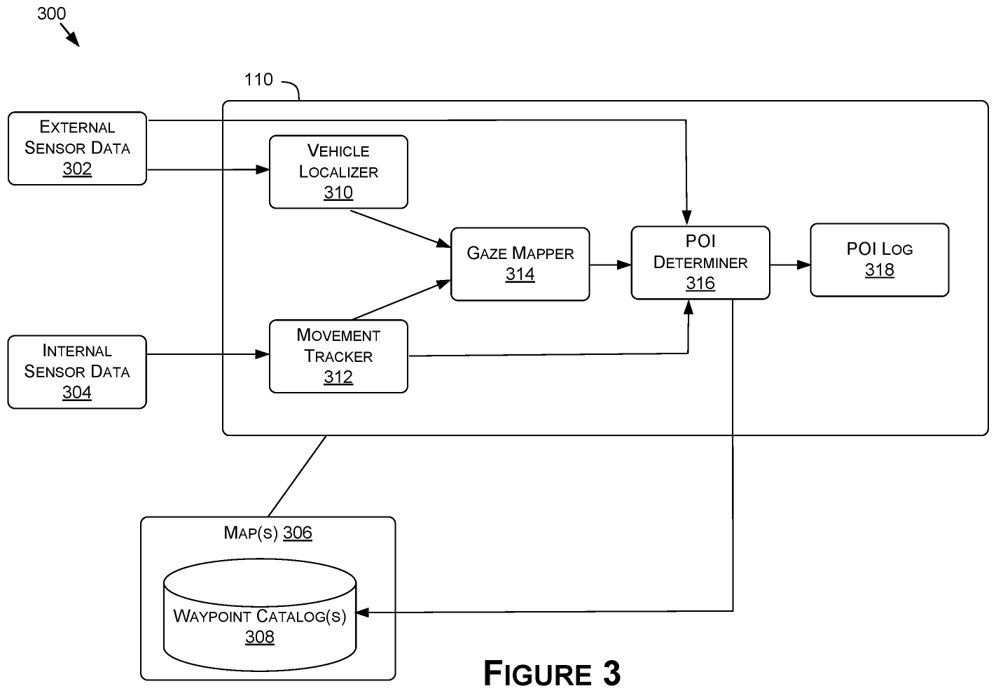

For instance, FIG. 3 is an example process 300 for determining a POI using gaze estimation, in accordance with some embodiments of the present disclosure. As shown, FIG. 3 may include external sensor data 302 (which may represent, and/or include, the sensor data 108), internal sensor data 304 (which may also represent, and/or include, the sensor data 108), a map(s) 306, a waypoint catalog(s) 308, the gaze component 110, a vehicle localizer 310, a movement tracker 312, a gaze mapper 314, a POI determiner 316, and a POI log 318.

In operation, the gaze component 110 may access the map(s) 306. The map(s) 306 may be a global navigation satellite systems (GNSS) map, a high definition (HD) map, a map generated by an entity (e.g., a company, a business, a corporation, an organization, etc.), a map type capable of providing near 1:1 scaling of a real-world environment, and/or another map type. The map(s) 306 may include and/or have access to the waypoint catalog(s) 308. The waypoint catalog(s) 308 may comprise any number of waypoints, where one or more waypoints (e.g., waypoint) correspond to a POI in a real-world environment. Additionally, data associated with one or more POIs (e.g., each POI) may be stored in the waypoint catalog(s) 308 in association with one or more corresponding waypoints (e.g., each waypoint). For example, a waypoint entry may include location information for a landmark, identifier information the landmark, etc.

The vehicle localizer 310 of the gaze component 110 may receive the external sensor data 302. As described herein, the external sensor data 302 may include image data generated by one or more external sensors (e.g., cameras) of the vehicle. The vehicle localizer 310 may use the external sensor data 302 to localize the vehicle within the map(s) 306. For example, the external sensor data 302 may include data indicating a semantic environment landmark(s). The semantic environment landmark(s) may then be matched to features of the map(s) 306 to determine a precise location of the vehicle within the map(s) 306 in real-time and/or near real-time.

Additionally, or alternatively, in some examples, the vehicle localizer 310 may use other types of sensor data 108 to determine the location of the vehicle within the map(s) 306. For instance, the vehicle localizer 310 may receive location data, such as Global Positioning System (GPS) data, triangulation data, and/or the like. The vehicle localizer 310 may then use the location data to determine the location of the vehicle within the map(s) 306.

The movement tracker 312 of the gaze component 110 may receive the internal sensor data 304. The internal sensor data 304 may correspond to sensor data generated using one or more in-cabin sensors, such as one or more in-cabin cameras, in-cabin near-infrared (NIR) sensors, in-cabin microphones, and/or the like. As such, the internal sensor data 304 may correspond to sensors with a sensory field or field of view internal to the vehicle (e.g., cameras with the occupant(s), such as the driver, in its field of view). However, in some examples, the internal sensor data 304 may include sensor data from any sensor with sensory fields external to the vehicle.

The movement tracker 312 may use the internal sensor data 304—e.g., sensor data from one or more in-cabin cameras, NIR cameras or sensors, and/or other eye-tracking sensor types—to determine gaze directions and movements, fixations, road scanning behaviors (e.g., road scanning patterns, distribution, and range), saccade information (e.g., velocity, direction, etc.), blink rate, smooth pursuit information (e.g., velocity, direction, etc.), and/or other information. The movement tracker 312 may determine time periods corresponding to certain states, such as how long a fixation lasts, and/or may track how many times certain states are determined—e.g., how many fixations, how many saccades, how many smooth pursuits, etc. The movement tracker 312 may monitor or analyze each eye individually, and/or may monitor or analyze both eyes together. For example, both eyes may be monitored in order to use triangulation for measuring a depth of an occupant's gaze. In some embodiments, the movement tracker 312 may execute one or more machine learning algorithms, deep neural networks, computer vison algorithms, image processing algorithms, mathematical algorithms, and/or the like to determine eye tracking information.

The movement tracker 312 may further use the internal sensor data 304—e.g., sensor data from one or more in-cabin cameras, microphones, pressure sensors, temperature sensors, etc.—to determine trigger actions, such as gestures, voice commands, button actuations, etc. In some examples, the movement tracker 312 may execute one or more machine learning algorithms, deep neural networks, computer vison algorithms, image processing algorithms, mathematical algorithms, natural language processing algorithms and/or the like to determine trigger action data.

The gaze mapper 314 may receive vehicle localization information from the vehicle localizer 310 and the eye tracking information from the movement tracker 312. Using the vehicle localization information and the eye tracking information, the gaze mapper 314 may access the map(s) 306 to map a user's field of view and gaze direction to the map(s) 306. A virtual representation of the user's field of view and gaze direction may further be generated and overlaid on the map(s) 306. In some examples, the gaze mapper 314 may map the gaze of a user to perception information of the vehicle—e.g., to map a representation of the gaze direction of the user to object detection (e.g., a POI detection bounding shape(s)) outputs of the vehicle.

The POI determiner 316 may receive mapping information from the gaze mapper 314. Using the mapping information, the POI determiner 316 may determine waypoints and corresponding POIs an occupant is viewing while the vehicle is traveling along a roadway. The POI determiner 316 may compare the virtual representation of the user's field of view with waypoint locations on the map(s) 306 from the waypoint catalog(s) 308 to determine POI(s) the user is viewing or potentially viewing. One or more viewable waypoints (e.g., each viewable waypoint) within the field of view of the user may be considered a candidate waypoint for the user to fixate their gaze. In some examples, one or more viewable waypoints (e.g., each viewable waypoint) within the field of view of the user may be stored in the POI log 318.

In some examples, the POI determiner 316 may identify waypoints to be stored in the POI log 318 based on a user viewing a POI for a threshold amount of time. For example, where a mapped gaze direction of a user overlaps with a waypoint location in the map(s) 306, the POI determiner 316 may determine that the user is viewing a POI associated with the waypoint at the waypoint location. In some examples, an overlap determination may include a threshold amount of overlap, such as 50% overlap (e.g., 50% of a bounding shape is overlapped by some portion of a gaze direction projection), 70% overlap, 90% overlap, etc. In other examples, any amount of overlap may satisfy the overlap determination, or complete overlap may satisfy the overlap determination. The POI determiner 316 may further track an amount of time the mapped gaze direction of the user overlaps with a waypoint location in the map(s) 306. When the amount of time exceeds a threshold, the POI determiner 316 may determine the user is interested in the POI and store the waypoint in the POI log 318 for later review.

In some examples, the POI determiner 316 may identify waypoints to be stored in the POI log 318 based on trigger action data and/or a user's gaze direction. For example, when a user performs a trigger action (e.g., output speech, such as an utterance), the POI determiner 316 may receive corresponding trigger action data from the movement tracker 312. The trigger action data may include a timestamp, which may be used to determine the user's gaze direction at the moment when the user performed the trigger action. For example, the POI determiner 316 may determine that at the moment a user spoke, the user's gaze overlapped with a particular landmark (or other POI type) in the field of view of the user.

In some examples, such as where the POI determiner 316 cannot determine a POI that the user is viewing—where no waypoint exists in the map(s) 306 along the path of the user's projected gaze, or the system does not use a map to determine POI or waypoint correlations—the POI determiner 316 may map the user's gaze direction to a field of view that may be captured by an external sensor of the vehicle to determine a POI the user is viewing. For example, the POI determiner 316 may receive eye tracking information from the movement tracker 312 and external sensor data 302, which may include image data captured by one or more cameras external to the vehicle. The POI determiner 316 may then map the user's gaze direction to the perception outputs (e.g., object detection, etc.) generated using the external sensor data 302 to determine a real-world view of the location the user is viewing. The POI determiner 316 may employ computer vision algorithms, machine learning, neural networks, and/or other processes to detect and/or process (e.g., using optical character recognition (OCR), image analysis, etc.) a POI the user is viewing. In some examples, once detected, the POI may be stored in the waypoint catalog(s) 308 and/or in the POI log 318.

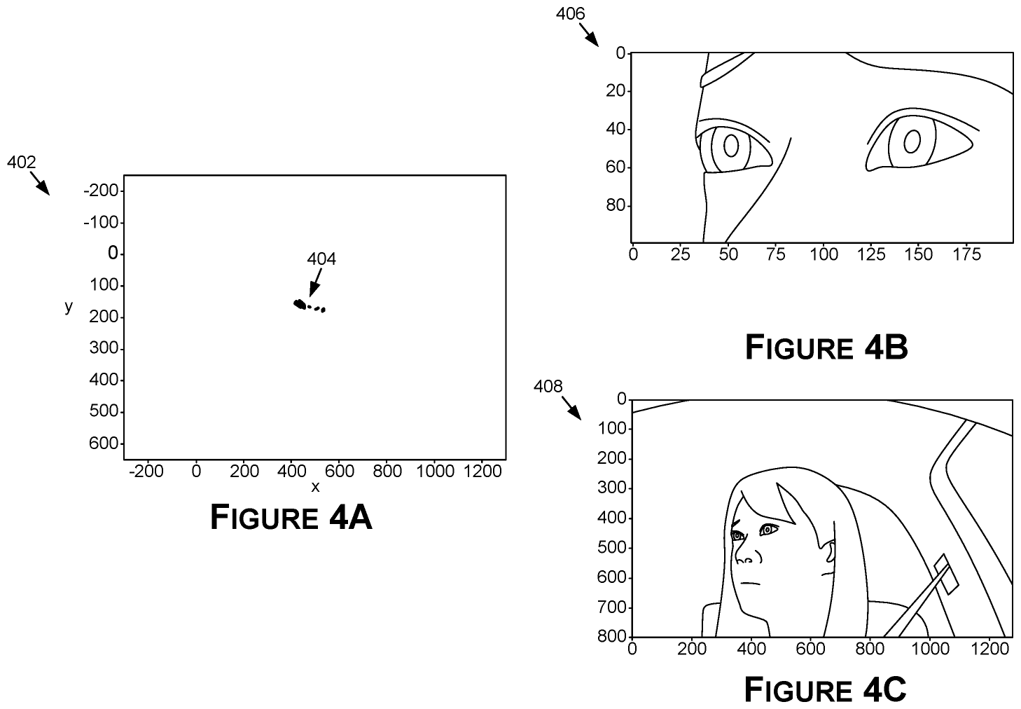

With reference to FIG. 4A, FIG. 4A depicts an example plot generated using eye movement information, in accordance with some embodiments of the present disclosure. FIG. 4A includes a graph 402 corresponding to a current (e.g., corresponding to a current time or a period of time—such as a second, three seconds, five seconds, etc.) gaze direction and gaze information. For example, the gaze direction may be represented by points 404, where the (x, y) locations in the graph 402 may have corresponding locations with respect to the vehicle. In some examples, the graph 402 may be used to determine a user has fixated the direction of their gaze on a POI for a threshold amount of time and/or to determine the direction of the user's gaze at the moment the system receives a trigger action.

With reference to FIGS. 4B-4C, FIGS. 4B-4C depict example illustrations of eye locations at a time step or frame used for determining eye movement information, in accordance with some embodiments of the present disclosure. Charts 406 and 408 include visualizations of a user—e.g., more focused on eyes of the user in the chart 406 and more broadly focused on the user in the chart 408—that may be used to generate the graph 402 of FIG. 4A. An orientation of a head and/or eyes of the occupant may be determined and used to determine a gaze direction and/or location for a current frame. In addition, the results over any number of frames (e.g., for two seconds of frames captures at 30 frames per second, or 60 frames) may be used to track movement types—such as saccades, blink rate, smooth pursuits, fixations, road scanning behaviors, and/or the like—that may be used to determine gaze direction at a moment in time. Additionally, the results may be processed to determine an interest level in POIs passed or approached by the user.

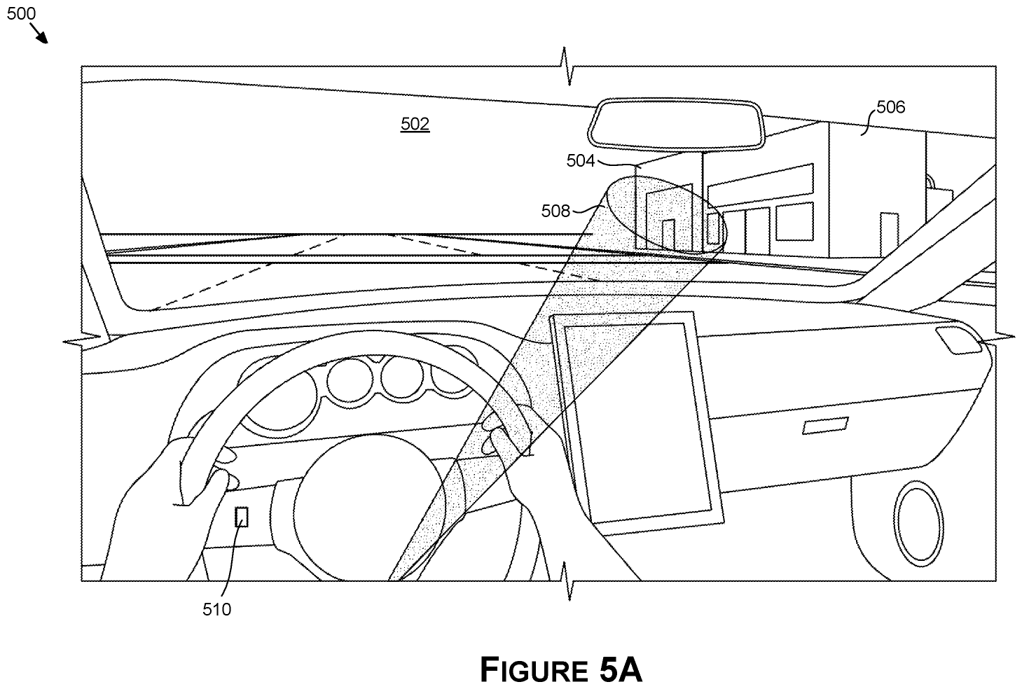

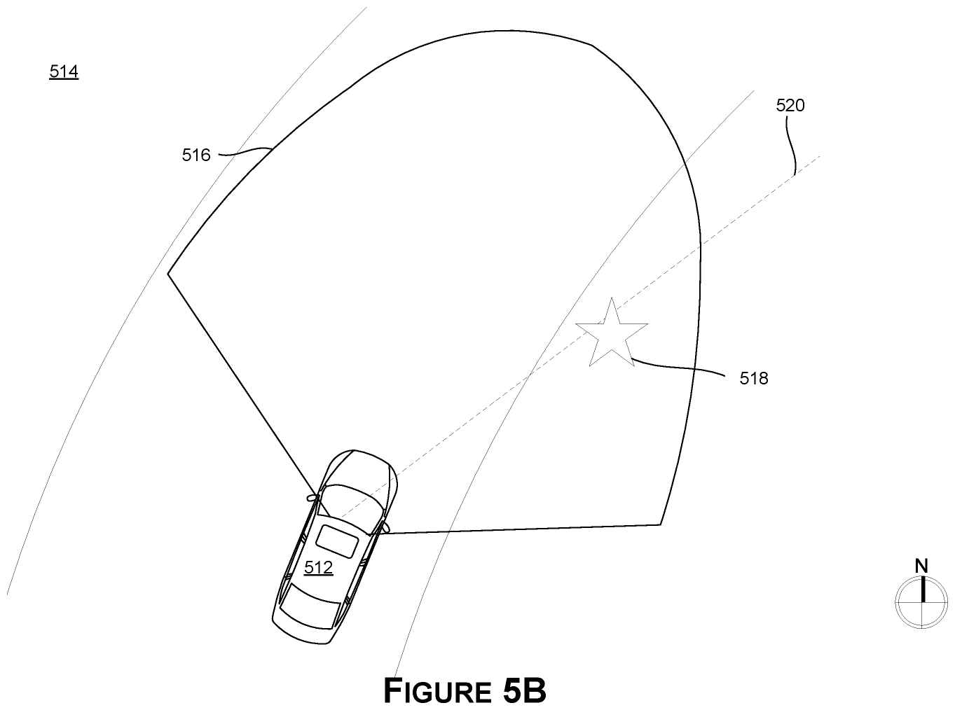

Referring to FIG. 5A, FIG. 5A depicts an example visualization 500 of a gaze direction representation extended exterior to the vehicle for determining a POI, in accordance with some embodiments of the present disclosure. The example visualization 500 includes a windshield 502, a landmark 504, a landmark 506, a projection 508, a trigger actuator 510, and a user.

In operation, a user may look through the windshield 502 and the projection 508 representing the direction of the user's gaze (e.g., based on internal sensor data 304) may be generated by the gaze component 110 and extended into the environment external to the vehicle. In some examples, using sensors external to the vehicle, the gaze component 110 may determine the landmark 504 and the landmark 506 are within the field of view of the user. In other examples, using the map(s) 306 and the waypoint catalog(s) 308, the gaze component 110 may determine that a waypoint corresponding to the landmark 504 exists in the waypoint catalog(s) 308 and that no waypoint corresponding to landmark 506 exists in the waypoint catalog(s) 308. The gaze component 110 may then determine that the projection 508 overlaps with the landmark 504 and/or a waypoint corresponding to the landmark 504. In some examples, the user may actuate the trigger actuator 510 while the projection 508 overlaps with the landmark 504 and data associated with the landmark 504 may be stored in the POI log 318. Additionally, or alternatively, according to examples discussed herein, data associated with the landmark 504 may be stored in the POI log 318 based on the projection 508 overlapping with the landmark 504 for a threshold amount of time, based on a gesture, based on a voice command, and/or another trigger action.

Turning to FIG. 5B, FIG. 5B depicts a top-down view of a vehicle localized on a map, in accordance with some embodiments of the present disclosure. FIG. 5B includes a vehicle 512, a map 514, a field of view 516, a waypoint 518, and a projected gaze direction 520.

In operation, the projected gaze direction 520 may be mapped to the map 514 (which may include, and/or represent, a map(s) 306 of FIG. 3), which includes waypoint 518. The gaze component 110 may then determine that the gaze direction 520 overlaps with the waypoint 518. In some examples, a user of the vehicle 512 may perform a trigger action (e.g., a gesture, a voice command, button actuation, and/or another trigger action) while the gaze direction 520 overlaps with the waypoint 518 to store data associated with the waypoint 518, and associated information, in the POI log 318. Additionally, or alternatively, according to examples discussed herein, the waypoint 518 may be stored in the POI log 318 based on the gaze direction 520 overlapping with the landmark 504 for a threshold amount of time.

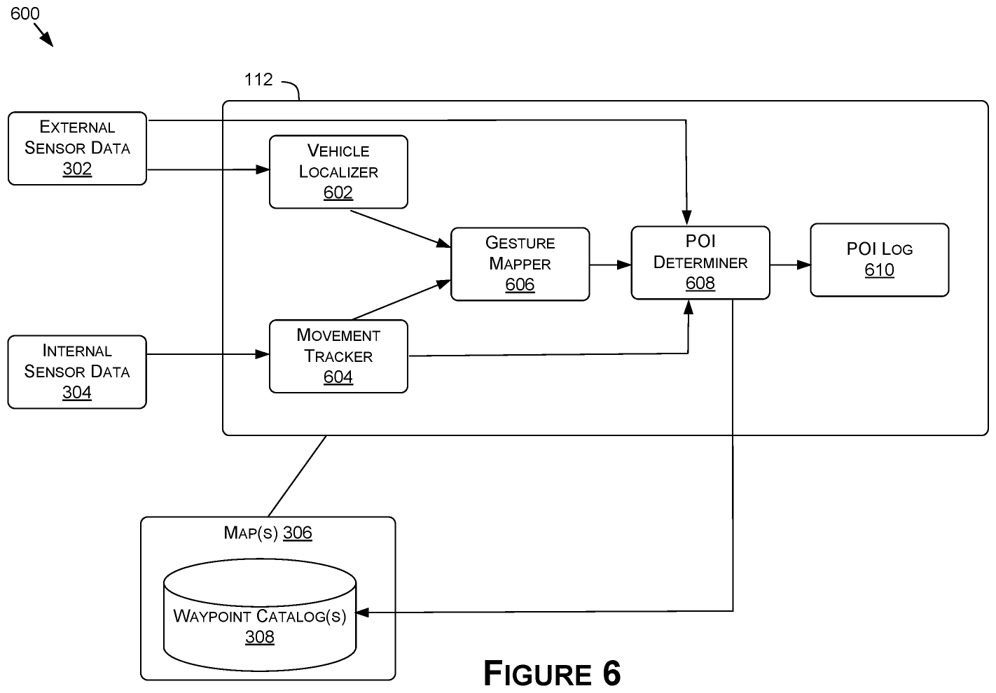

In some examples, the gesture component 112 may perform one or more similar processes in order to determine the POI. For instance, FIG. 6 is an example process 600 for determining a POI using gesture estimation, in accordance with some embodiments of the present disclosure. As shown, FIG. 6 may include the external sensor data 302, the internal sensor data 304, the map(s) 306, the waypoint catalog(s) 308, the gesture component 112, a vehicle localizer 602 (which may represent, and/or include, the vehicle localizer 310), a movement tracker 604, a gesture mapper 606, a POI determiner 608 (which may represent, and/or include, the POI determiner 316), and a POI log 610 (which may represent, and/or include, the POI log 318).

In operation, the gesture component 112 may access the map(s) 306. The vehicle localizer 602 of the gesture component 112 may also receive the external sensor data 302. As described herein, the external sensor data 302 may include image data generated by one or more external sensors (e.g., cameras) of the vehicle. The vehicle localizer 602 may use the external sensor data 302 to localize the vehicle within the map(s) 306. For example, the external sensor data 302 may include data indicating semantic environment landmarks. The semantic environment landmarks may then be matched to features of the map(s) 306 to determine a precise location of the vehicle within the map(s) 306 in real-time.

The vehicle localizer 602 of the gaze component 110 may receive the external sensor data 302. As described herein, the external sensor data 302 may include image data generated by one or more external sensors (e.g., cameras) of the vehicle. The vehicle localizer 602 may use the external sensor data 302 to localize the vehicle within the map(s) 306. For example, the external sensor data 302 may include data indicating a semantic environment landmark(s). The semantic environment landmark(s) may then be matched to features of the map(s) 306 to determine a precise location of the vehicle within the map(s) 306 in real-time and/or near real-time.

Additionally, or alternatively, in some examples, the vehicle localizer 602 may use other types of sensor data 108 to determine the location of the vehicle within the map(s) 306. For instance, the vehicle localizer 602 may receive location data, such as Global Positioning System (GPS) data, triangulation data, and/or the like. The vehicle localizer 602 may then use the location data to determine the location of the vehicle within the map(s) 306.

The movement tracker 604 of the gesture component 112 may receive the internal sensor data 304. As described herein, internal sensor data 304 may correspond to sensor data generated using one or more in-cabin sensors, such as one or more in-cabin cameras, in-cabin near-infrared (NIR) sensors, in-cabin microphones, and/or the like. As such, the internal sensor data 304 may correspond to sensors with a sensory field or field of view internal to the vehicle (e.g., cameras with the occupant(s), such as the driver, in its field of view). However, in some embodiments, the internal sensor data 304 may include sensor data from any sensors with sensory fields external to the vehicle.

The movement tracker 604 may use the internal sensor data 304—e.g., sensor data from one or more in-cabin cameras, NIR cameras or sensors, and/or other eye-tracking sensor types—to determine gesture directions and movements, fixations, road scanning behaviors (e.g., road scanning patterns, distribution, and range), saccade information (e.g., velocity, direction, etc.), blink rate, smooth pursuit information (e.g., velocity, direction, etc.), and/or other information. The movement tracker 604 may determine time periods corresponding to certain states, such as how long a fixation lasts, and/or may track how many times certain states are determined—e.g., how many fixations, how many saccades, how many smooth pursuits, etc. The movement tracker 604 may monitor or analyze one or more portions of the user, such as a hand(s) of the user. In some embodiments, the movement tracker 604 may execute one or more machine learning algorithms, deep neural networks, computer vison algorithms, image processing algorithms, mathematical algorithms, and/or the like to determine eye tracking information.

The movement tracker 604 may further use the internal sensor data 304—e.g., sensor data from one or more in-cabin cameras, microphones, pressure sensors, temperature sensors, etc.—to determine trigger actions, such as gestures, voice commands, button actuations, etc. In some embodiments, the movement tracker 604 may execute one or more machine learning algorithms, deep neural networks, computer vison algorithms, image processing algorithms, mathematical algorithms, natural language processing algorithms and/or the like to determine trigger action data.

The gesture mapper 606 may receive vehicle localization information from the vehicle localizer 602 and the gesture tracking information from the movement tracker 604. Using the vehicle localization information and the gesture tracking information, the gesture mapper 606 may access the map(s) 306 to map a user's gesture direction to the map(s) 306. A virtual representation of the user's gesture direction may further be generated and overlaid on the map(s) 306. In some embodiments, the gesture mapper 606 may map the gesture of a user to perception information of the vehicle—e.g., to map a representation of the gesture direction of the user to object detection (e.g., POI detection bounding shapes) outputs of the vehicle.

The POI determiner 608 may receive mapping information from the gesture mapper 606. Using the mapping information, the POI determiner 608 may determine waypoints and corresponding POIs an occupant is viewing while the vehicle is traveling along a roadway. The POI determiner 608 may compare the virtual representation of the user's gesture direction with waypoint locations on the map(s) 306 from the waypoint catalog(s) 308 to determine POI(s) the user is viewing or potentially viewing. One or more viewable waypoints (e.g., each viewable waypoint) within the field of view of the user may be considered a candidate waypoint for the user to fixate their gesture. In some examples, one or more viewable waypoints (e.g., each viewable waypoint) within the field of view of the user may be stored in the POI log 318.

In some embodiments, the POI determiner 608 may identify waypoints to be stored in the POI log 318 based on a user gesturing towards a POI for a threshold amount of time. For example, where a mapped gesture direction of a user overlaps with a waypoint location in the map(s) 306, the POI determiner 608 may determine that the user is gesturing towards a POI associated with the waypoint at the waypoint location. The POI determiner 608 may further track an amount of time the mapped gesture direction of the user overlaps with a waypoint location in the map(s) 306. When the amount of time exceeds a threshold, the POI determiner 608 may determine the user is interested in the POI and store the waypoint in the POI log 610 for later review.

In some embodiments, the POI determiner 608 may identify waypoints to be stored in the POI log 610 based on trigger action data and/or a user's gesture direction. For example, when a user performs a trigger action, the POI determiner 608 may receive corresponding trigger action data from the movement tracker 604. The trigger action data may include a timestamp, which may be used to determine the user's gesture direction at the moment when the user performed the trigger action. For example, the POI determiner 608 may determine that at the moment a user actuated a button (e.g., on a steering wheel, on a touch display, on a console, etc.) of the vehicle or otherwise indicated (e.g., physically, verbally, by a gesture, etc.) interest in a POI, the user's gesture direction overlapped with a particular landmark (or other POI type) in the field of view of the user.

In some embodiments, such as where the POI determiner 608 cannot determine a POI that the user is viewing—where no waypoint exists in the map(s) 306 along the path of the user's projected gesture direction, or the system does not use a map to determine POI or waypoint correlations—the POI determiner 608 may map the user's gesture direction to a field of view that may be captured by an external sensor of the vehicle to determine a POI the user is viewing. For example, the POI determiner 608 may receive gesture tracking information from the movement tracker 604 and external sensor data 302, which may include image data captured by one or more cameras external to the vehicle. The POI determiner 608 may then map the user's gesture direction to the perception outputs (e.g., object detection, etc.) generated using the external sensor data 302 to determine a real-world view of the location the user is gesturing. The POI determiner 608 may employ computer vision algorithms, machine learning, neural networks, and/or other processed to detect and/or process (e.g., using optical character recognition (OCR), image analysis, etc.) a POI the user is gesturing. In some examples, once detected, the POI may be stored in the waypoint catalog(s) 308 and/or in the POI log 610.

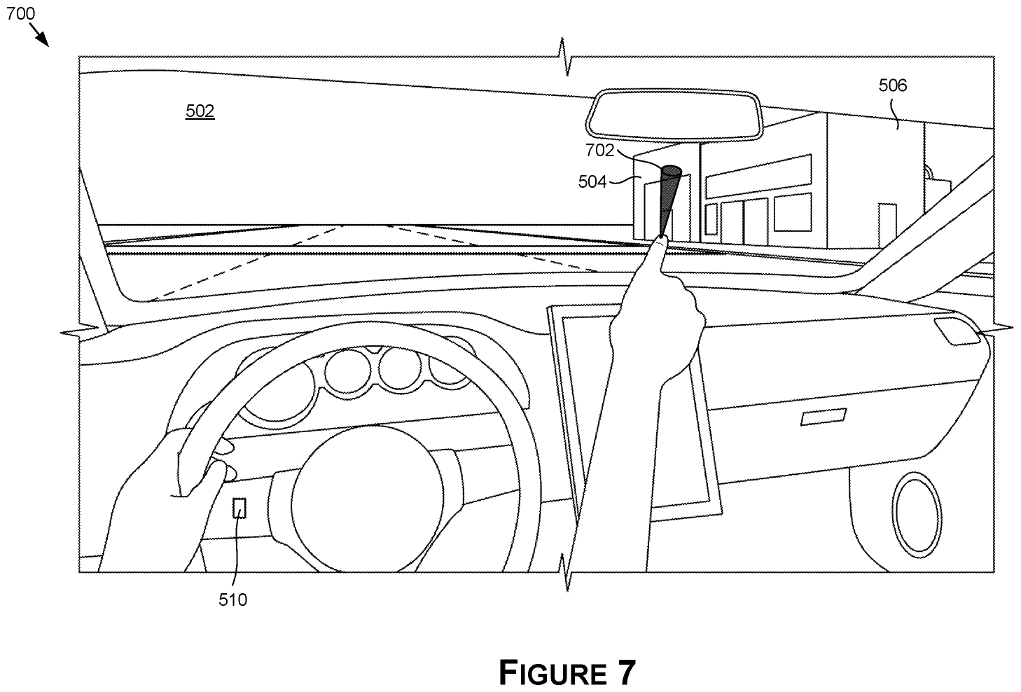

Referring to FIG. 7, FIG. 7 depicts an example visualization 700 of a gesture direction representation extended exterior to the vehicle for determining a POI, in accordance with some embodiments of the present disclosure. The example visualization 700 includes the windshield 502, the landmark 504, the landmark 506, a projection 702, the trigger actuator 510, and the user.

In operation, the user may point through the windshield 502 and the projection 702 representing the direction of the user's gesture (e.g., based on internal sensor data 304) may be generated by the gesture component 112 and extended into the environment external to the vehicle. In some examples, using sensors external to the vehicle, the gesture component 112 may determine the landmark 504 and the landmark 506 are within the field of view of the user. In other examples, using the map(s) 306 and the waypoint catalog(s) 308, the gesture component 112 may determine that a waypoint corresponding to the landmark 504 exists in the waypoint catalog(s) 308 and that no waypoint corresponding to landmark 506 exists in the waypoint catalog(s) 308. The gesture component 112 may then determine that the projection 702 overlaps with the landmark 504 and/or a waypoint corresponding to the landmark 504. In some examples, the user may actuate the trigger actuator 510 while the projection 702 overlaps with the landmark 504 and data associated with the landmark 504 may be stored in the POI log 610. Additionally, or alternatively, according to examples discussed herein, data associated with the landmark 504 may be stored in the POI log 610 based on the projection 702 overlapping with the landmark 504 for a threshold amount of time, based on a gesture, based on a voice command, and/or another trigger action.

Referring back to the example of FIG. 1, the process 100 may include the gaze component 110 and/or the gesture component 112 outputting context data 114. For instance, and as described herein, based on the gaze component 110 and/or the gesture component 112 determining a POI(s), the gaze component 110 and/or the gesture component 112 may use the POI(s) (e.g., from the POI log 318 and/or the POI log 610) to determine a context associated with the speech represented by the audio data 104. In some examples, the context may represent information associated with the POI(s). For a first example, if the POI is a landmark, then the context may include an identifier (e.g., a name, a nickname, etc.) associated with the landmark, an attribute (e.g., a color, a size, a shape, etc.) associated with the landmark, and/or any other information associated with the landmark. For a second example, if the POI is a person, then the context may include an identifier (e.g., a name, a nickname, etc.) associated with the person. While these are just a couple examples of context associated with a POI, in other examples, the context may include any other types of information associated with the POI.

In some examples, the process 100 may include the vehicle generating additional context data 116 associated with the audio data 104. As described herein, the additional context data 116 may include, but is not limited to, location data associated with the vehicle (and/or the user), time data, route data, and/or the like. The location data may represent a geographic area, such as a street, a neighborhood, a county, a city, a state, a country, and/or any other geographic area that the user is located. Additionally, the time data may represent a time that the speech was output by the user and/or the audio data 104 was generated. The time may include the second, minute, hour, day, week, month, year, and/or the like. Furthermore, the route data may indicate a current route associated with the vehicle, such as the origination location and/or the destination location.

The process 100 may then include inputting the text data 106, the context data 114, and/or the additional context data 116 into a language model(s) 118. In some examples, to input the data, the intent may be appended with the slot(s), the context represented by the context data 114, and/or the context represented by the additional context data 116. However, in other examples, the text data 106, the context data 114, and/or the additional context data 116 may be separately input into the language model(s) 118. As described herein, the language model(s) 118 may include any type of language model(s), such as, but not limited to, a generative language model(s) (e.g., a GPT(s), etc.), a representation language model(s) (e.g., a BERT(s), etc.), and/or any other type of language model. The language model(s) 118 may be trained to process the intent, the information associated with the slot(s), and/or the context. Based on the processing, the language model(s) 118 may output data 120 associated with the intent. For instance, and using the example of FIG. 2, if the intent includes “requesting information,” the slot includes information “building” and “glass,” and the context includes an identifier (e.g., a name) of the building, then the language model(s) 118 may output data 120 representing information associated with the building.

In some examples, the output data 120 may include audio data representing one or more words describing the information. For instance, and using the example above, the audio data may represent words describing or corresponding to the name of the building, the date the building was built, and/or any other information. In some examples, one or more components of the vehicle may use the output data 120 to generate a different type of output for the user. For example, the component(s) of the vehicle may use the output data 120 to generate image data representing one or more images that include the information associated with the building. In either example, the vehicle may then provide the output to the user.

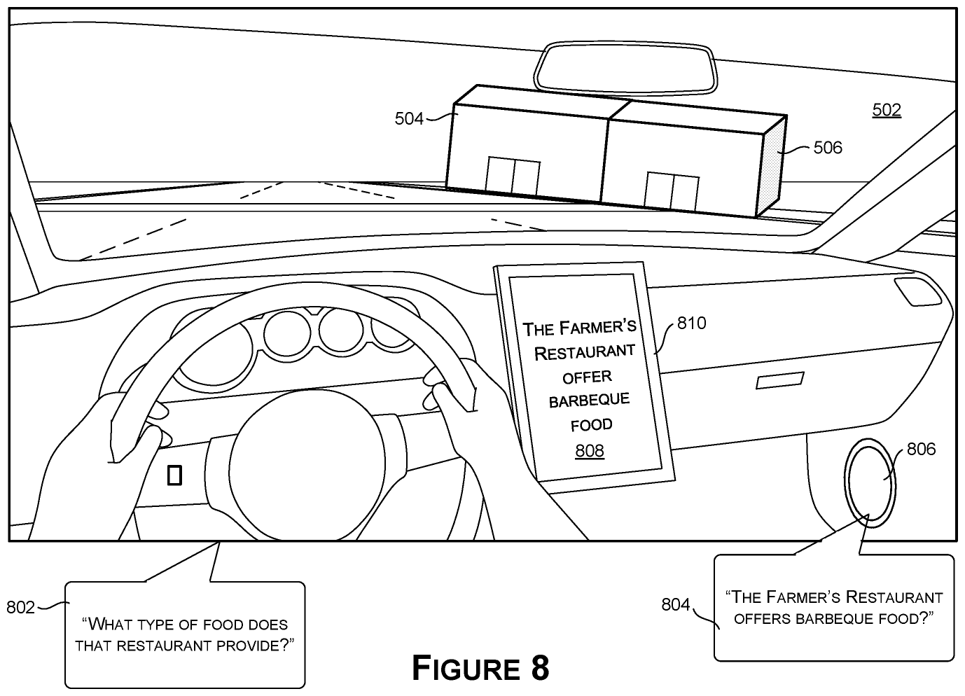

For instance, FIG. 8 illustrates an example of the language model(s) 118 causing content to be provided to a user, in accordance with some examples of the present disclosure. As shown, the user may initially provide speech representing an utterance 802 that includes “What type of food does that restaurant provide?” As such, the speech model(s) 102 may perform one or more of the processes described herein to process audio data 104 representing the utterance 802 and, based on the processing, output text data 106 associated with the utterance 802. In the example of FIG. 8, the text data 106 may represent an intent that includes “request information” and information for slots that includes “food” and “restaurant.” Additionally, the gaze component 110 and/or the gesture component 112 may perform one or more of the processes described herein to process sensor data 108 representing the user. Based on the processing, the gaze component 110 and/or the gesture component 112 may output context data 114 associated with the audio data 104. In the example of FIG. 8, the context data 114 may represent an identifier (e.g., a name, such as “Farmer's Restaurant” in the example of FIG. 8) of the landmark 504 (e.g., the restaurant) that the user was focused on when outputting the utterance 802.

The language model(s) 118 may then process the text data 106 and the context data 114. Based on the processing, the language model(s) 118 may output data 120 representing the information associated with the landmark 504. For instance, and in the example of FIG. 8, the output data 120 may represent one or more words, such as “The Farmer's Restaurant offers barbeque food.” The vehicle may then output content associated with the output data 120 to the user. For a first example, if the output data 120 is audio data representing the one or more words, then the vehicle may output sound 804 represented by the audio data using a speaker(s) 806. Additionally, or alternatively, the vehicle may use the output data 120 to generate image data representing content 808 associated with the information. The vehicle may then cause a display 810 to present the content 808 to the user.

While the example of FIG. 8 illustrates the audio data and the image data as including the same information from the output data 120, in other examples, the audio data may represent different information from the image data. For example, the content 808 being presented by the display 810 may provide additional information associated with the landmark 504, such as a food menu of the restaurant. In some examples, the language model(s) 118 (and/or one or more other model(s)) may determine the additional information by processing the text data 106 and/or the context data 114.

While the examples of FIGS. 1-8 describe performing the processes when the vehicle includes a user, in other examples, similar processes may be performed when more than one user is located within the vehicle. In such examples, the vehicle may perform one or more additional processes to initially identify which user within the vehicle output the speech. In some examples, the vehicle may identify the user based on processing the sensor data 108 using one or more image processing techniques to determine which of the users is speaking at the time period the audio data 104 representing the speech was generated. For instance, the image processing technique(s) may determine a specific user's mouth was moving during the time period that the audio data 104 was being generated while the other users' mouths were not moving during the time period that the audio data 104 was being generated. As such, the vehicle may determine that the specific user was the one that output the speech. The vehicle may then perform the processes described herein to determine the POI that the specific user was focused on during the time that the specific user output the speech. This way, the vehicle may verify that the correct context data 114 is generated for the audio data 104.

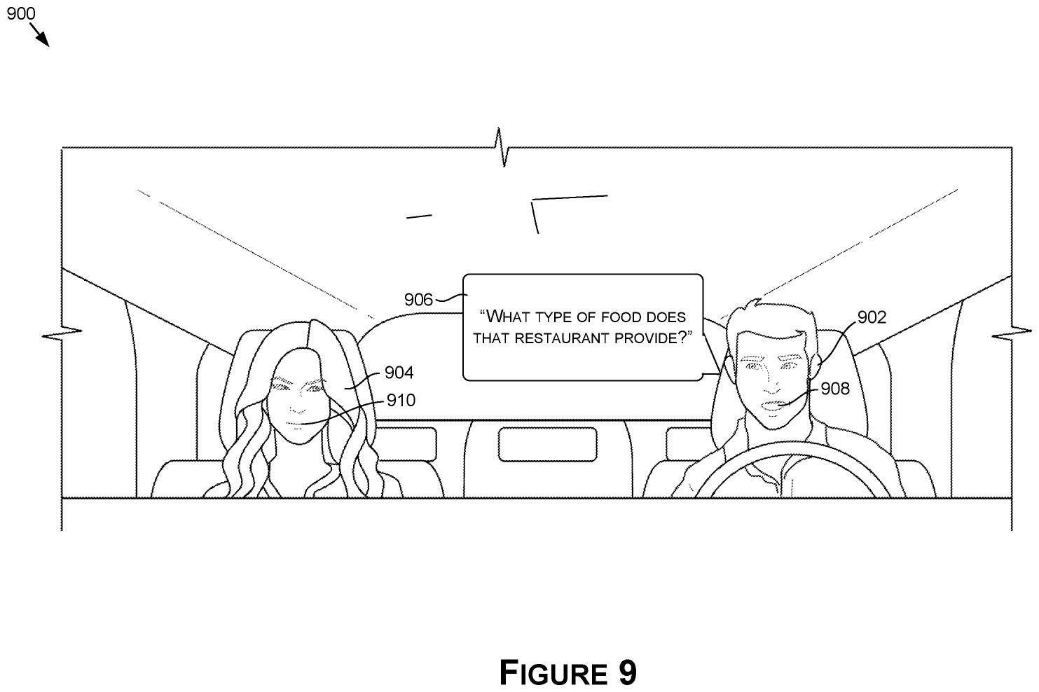

For instance, FIG. 9 illustrates an example visualization 900 of identifying a user that output speech, in accordance with some examples of the present disclosure. In the example of FIG. 9, a sensor(s) located within the vehicle may generate sensor data 108 (e.g., image data) representing an image depicting a first user 902 and a second 904 located within the vehicle. The vehicle may then use image processing technique(s) to process the sensor data 108 in order to determine that speech 906 is associated with the first user 902. For instance, the image processing technique(s) may determine that a mouth 908 of the first user 902 was open and/or moving when the speech 906 was output and/or audio data 104 representing the speech 906 was generated. Additionally, or alternatively, the image processing technique(s) may determine that a mouth 910 of the second user 904 was shut and/or not moving when the speech 906 was output and/or audio data 104 representing the speech 906 was generated.

While the example of FIG. 9 describes using an image processing technique(s) to determine that the speech 906 is associated with the first user 902, in other examples, the vehicle may use one or more additional and/or alternative techniques. For a first example, the vehicle may use one or more voice recognition techniques to analyze the audio data 104 representing the speech 906. Based on the processing, the voice recognition technique(s) may determine that the speech 906 is associated with the first user 902. For a second example, the vehicle may determine that the first user 902 was providing an input, such as to the trigger actuator 510, when the speech 906 was output and/or when the audio data 104 representing the speech 906 was generated. While these are just a couple additional example techniques of how the vehicle may associate the speech 906 with the first user 902, in other examples, the vehicle may use additional and/or alternative techniques.

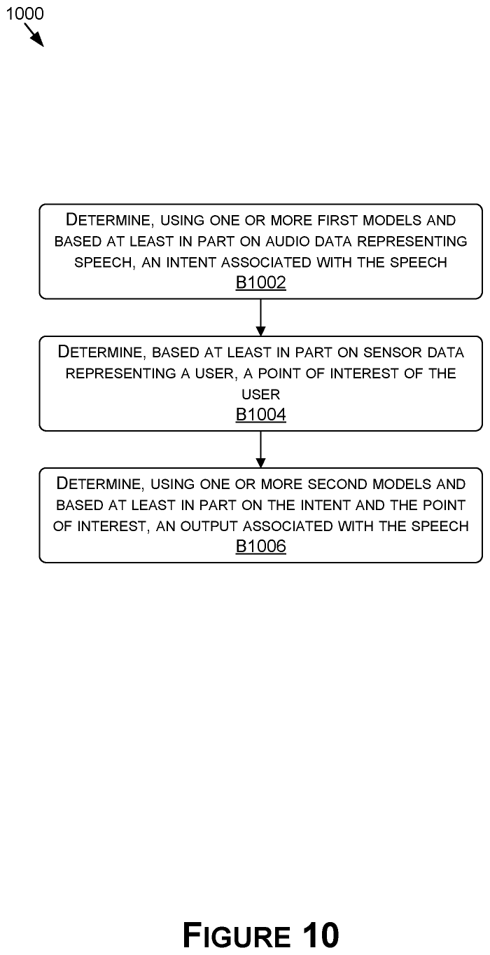

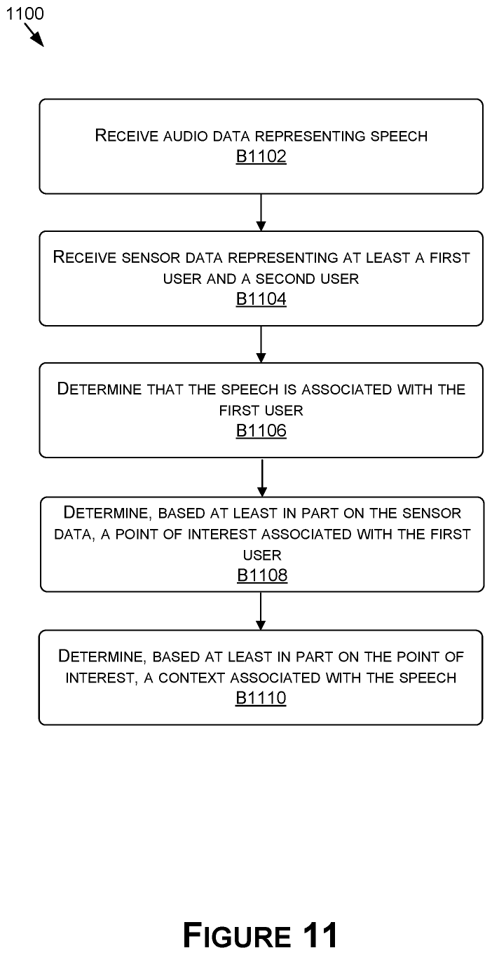

Now referring to FIGS. 10-11, each block of methods 1000 and 1100, described herein, comprises a computing process that may be performed using any combination of hardware, firmware, and/or software. For instance, various functions may be carried out by a processor executing instructions stored in memory. The methods 1000 and 1100 may also be embodied as computer-usable instructions stored on computer storage media. The methods 1000 and 1100 may be provided by a standalone application, a service or hosted service (standalone or in combination with another hosted service), or a plug-in to another product, to name a few. In addition, the methods 1000 and 1100 re described, by way of example, with respect to the system of FIG. 1. However, these methods 1000 and 1100 may additionally or alternatively be executed by any one system, or any combination of systems, including, but not limited to, those described herein.

FIG. 10 is a flow diagram showing a method 1000 for using scene-aware context for dialogue systems, in accordance with some embodiments of the present disclosure. The method 1000, at block 1002, may include determining, using one or more first machine learning (e.g., language) models and based at least in part on audio data representing speech, an intent associated with the speech. For instance, audio data 104 may be input into the speech model(s) 102. As described herein, the audio data 104 may represent speech, such as a user utterance requesting a task to be performed (e.g., “Please provide information about that structure”). The speech model(s) 102 may then process the audio data 104 and, based on the processing, output text data 106 representing the intent (e.g., “request information”) associated with the speech. In some examples, the text data 106 output by the language model(s) 118 may further represent information for one or more slots (e.g., “structure”) associated with the intent.

The process 1000, at block B1004, may include determining, based at least in part on sensor data representing a user, a point of interest of the user. For instance, sensor data 108 representing the user may be processed by the gaze component 110 and/or the gesture component 112. Based on processing the sensor data 108, the gaze component 110 and/or the gesture component 112 may determine a POI associated with the user. For example, the gaze component 110 and/or the gesture component 112 may determine that the user is focused on a landmark, a person, and/or any other object located within the environment for which the user is located. The gaze component 110, the gesture component 112, and/or another component may then generate context data based at least in part on the POI. As described herein, the context data 114 may represent information associated with the POI, such as an identifier of the POI.

The process 1000, at block B1006, may include determining, using one or more second models and based at least in part on the intent and the point of interest, an output associated with the speech. For instance, the text data 106 and the context data 114 may be input into the language model(s) 118. In some examples, additional context data 116 may also be input into the language model(s) 118. The language model(s) 118 may then process the data and based on the processing, output data 120 associated with the speech. For a first example, and using the example above, if the intent includes “requesting information” for the structure and the context data 114 represents the identifier of the structure, then the language model(s) 118 may output data 120 representing the information associated with the specific structure that the user was focused on when outputting the speech. For a second example, if the intent includes “booking a reservation” and the context data 114 represents an identifier for a restaurant, then the language model(s) 118 may output data 120 that may be used to book the reservation at the restaurant.

FIG. 11 is a flow diagram showing a method 1100 for determining a context associated with speech when multiple users are located within a vehicle, in accordance with some embodiments of the present disclosure. The process 1100, at block B1102, may include receiving audio data representing speech. For instance, the vehicle may use one or more sensors to generate the audio data 104 representing the speech. As described herein, the speech may represent a user utterance requesting a task to be performed (e.g., “Please provide information about that structure”). The vehicle may then use the speech model(s) 102 to process the audio data 104 and, based on the processing, output text data 106 representing the intent (e.g., “request information”) associated with the speech. In some examples, the text data 106 output by the language model(s) 118 may further represent information for one or more slots (e.g., “structure”) associated with the intent.

The process 1100, at block B1104, may include receiving sensor data representing at least a first user and a second user. For instance, the vehicle may use one or more sensors to generate the sensor data 108 representing the first user and the second user. In some examples, the sensor data 108 may include image data from a single camera, where the image data represents an image depicting the first user and the second user. In some examples, the sensor data 108 may include first image data generated by a first camera and second image data generated by a second camera, where the first image data represent a first image depicting the first user and the second image data represents a second image depicting the second user. In some examples, the first user may be a driver and the second user may be a passenger. In other examples, both the first and second users may be passengers.

The process 1100, at block B1106, may include determining that the speech is associated with the first user. For instance, the vehicle may process the audio data 104 and/or the sensor data 108 and, based on the processing, determine that the speech is associated with the first user. In some examples, to make the determination, the vehicle may process the sensor data 108 using one or more image processing techniques. Based on the processing, the vehicle may determine that the first user was speaking (e.g., the first user's mouth was moving) during a time that the audio data 104 was generated. In some examples, to make the determination, the vehicle may process the audio data 104 using one or more voice recognition techniques. Based on the processing, the vehicle may determine that the speech is associated with the first user. While these are just a couple example techniques of how the vehicle may determine that the speech is associated with the first user, in other examples, the vehicle may use additional and/or alternative techniques.

The process 1100, at block B1108, may include determining, based at least in part on the sensor data, a point of interest associated with the first user. For instance, the sensor data 108 may be processed by the gaze component 110 and/or the gesture component 112. Based on processing the sensor data 108, the gaze component 110 and/or the gesture component 112 may determine a POI associated with the first user. For example, the gaze component 110 and/or the gesture component 112 may determine that the first user is focused on a landmark, a person, and/or any other object located within the environment for which the first user is located.

The process 1100, at block B1110, may include determining, based at least in part on the point of interest, a context associated with the speech. For instance, the gaze component 110, the gesture component 112, and/or another component may then generate the context data 114 based at least in part on the POI. As described herein, the context data 114 may represent information associated with the POI, such as an identifier of the POI. In some examples, the vehicle may associate the context data 114 with the speech based on the determination that the first user is associated with the speech.

Example Autonomous Vehicle

FIG. 12A is an illustration of an example autonomous vehicle 1200, in accordance with some embodiments of the present disclosure. The autonomous vehicle 1200 (alternatively referred to herein as the “vehicle 1200”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a vehicle coupled to a trailer (e.g., a semi-tractor-trailer truck used for hauling cargo), and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 1200 may be capable of functionality in accordance with one or more of Level 3-Level 5 of the autonomous driving levels. The vehicle 1200 may be capable of functionality in accordance with one or more of Level 1-Level 5 of the autonomous driving levels. For example, the vehicle 1200 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 1200 or other machine, such as being fully autonomous, being highly autonomous, being conditionally autonomous, being partially autonomous, providing assistive autonomy, being semi-autonomous, being primarily autonomous, or other designation.

The vehicle 1200 may include components such as a chassis, a vehicle body, wheels (e.g., 2, 4, 6, 8, 18, etc.), tires, axles, and other components of a vehicle. The vehicle 1200 may include a propulsion system 1250, such as an internal combustion engine, hybrid electric power plant, an all-electric engine, and/or another propulsion system type. The propulsion system 1250 may be connected to a drive train of the vehicle 1200, which may include a transmission, to enable the propulsion of the vehicle 1200. The propulsion system 1250 may be controlled in response to receiving signals from the throttle/accelerator 1252.

A steering system 1254, which may include a steering wheel, may be used to steer the vehicle 1200 (e.g., along a desired path or route) when the propulsion system 1250 is operating (e.g., when the vehicle is in motion). The steering system 1254 may receive signals from a steering actuator 1256. The steering wheel may be optional for full automation (Level 5) functionality.

The brake sensor system 1246 may be used to operate the vehicle brakes in response to receiving signals from the brake actuators 1248 and/or brake sensors.

Controller(s) 1236, which may include one or more system on chips (SoCs) 1204 (FIG. 12C) and/or GPU(s), may provide signals (e.g., representative of commands) to one or more components and/or systems of the vehicle 1200. For example, the controller(s) may send signals to operate the vehicle brakes via one or more brake actuators 1248, to operate the steering system 1254 via one or more steering actuators 1256, to operate the propulsion system 1250 via one or more throttle/accelerators 1252. The controller(s) 1236 may include one or more onboard (e.g., integrated) computing devices (e.g., supercomputers) that process sensor signals, and output operation commands (e.g., signals representing commands) to enable autonomous driving and/or to assist a human driver in driving the vehicle 1200. The controller(s) 1236 may include a first controller 1236 for autonomous driving functions, a second controller 1236 for functional safety functions, a third controller 1236 for artificial intelligence functionality (e.g., computer vision), a fourth controller 1236 for infotainment functionality, a fifth controller 1236 for redundancy in emergency conditions, and/or other controllers. In some examples, a single controller 1236 may handle two or more of the above functionalities, two or more controllers 1236 may handle a single functionality, and/or any combination thereof.

The controller(s) 1236 may provide the signals for controlling one or more components and/or systems of the vehicle 1200 in response to sensor data received from one or more sensors (e.g., sensor inputs). The sensor data may be received from, for example and without limitation, global navigation satellite systems (“GNSS”) sensor(s) 1258 (e.g., Global Positioning System sensor(s)), RADAR sensor(s) 1260, ultrasonic sensor(s) 1262, LIDAR sensor(s) 1264, inertial measurement unit (IMU) sensor(s) 1266 (e.g., accelerometer(s), gyroscope(s), magnetic compass(es), magnetometer(s), etc.), microphone(s) 1296, stereo camera(s) 1268, wide-view camera(s) 1270 (e.g., fisheye cameras), infrared camera(s) 1272, surround camera(s) 1274 (e.g., 360 degree cameras), long-range and/or mid-range camera(s) 1298, speed sensor(s) 1244 (e.g., for measuring the speed of the vehicle 1200), vibration sensor(s) 1242, steering sensor(s) 1240, brake sensor(s) (e.g., as part of the brake sensor system 1246), and/or other sensor types.

One or more of the controller(s) 1236 may receive inputs (e.g., represented by input data) from an instrument cluster 1232 of the vehicle 1200 and provide outputs (e.g., represented by output data, display data, etc.) via a human-machine interface (HMI) display 1234, an audible annunciator, a loudspeaker, and/or via other components of the vehicle 1200. The outputs may include information such as vehicle velocity, speed, time, map data (e.g., the High Definition (“HD”) map 1222 of FIG. 12C), location data (e.g., the vehicle's 1200 location, such as on a map), direction, location of other vehicles (e.g., an occupancy grid), information about objects and status of objects as perceived by the controller(s) 1236, etc. For example, the HMI display 1234 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 1200 further includes a network interface 1224 which may use one or more wireless antenna(s) 1226 and/or modem(s) to communicate over one or more networks. For example, the network interface 1224 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), etc. The wireless antenna(s) 1226 may also enable communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

FIG. 12B is an example of camera locations and fields of view for the example autonomous vehicle 1200 of FIG. 12A, in accordance with some embodiments of the present disclosure. The cameras and respective fields of view are one example embodiment and are not intended to be limiting. For example, additional and/or alternative cameras may be included and/or the cameras may be located at different locations on the vehicle 1200.

The camera types for the cameras may include, but are not limited to, digital cameras that may be adapted for use with the components and/or systems of the vehicle 1200. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom designed (three dimensional (“3D”) printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 1200 (e.g., front-facing cameras) may be used for surround view, to help identify forward facing paths and obstacles, as well aid in, with the help of one or more controllers 1236 and/or control SoCs, providing information critical to generating an occupancy grid and/or determining the preferred vehicle paths. Front-facing cameras may be used to perform many of the same ADAS functions as LIDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 1270 that may be used to perceive objects coming into view from the periphery (e.g., pedestrians, crossing traffic or bicycles). Although only one wide-view camera is illustrated in FIG. 12B, there may be any number (including zero) of wide-view cameras 1270 on the vehicle 1200. In addition, any number of long-range camera(s) 1298 (e.g., a long-view stereo camera pair) may be used for depth-based object detection, especially for objects for which a neural network has not yet been trained. The long-range camera(s) 1298 may also be used for object detection and classification, as well as basic object tracking.

Any number of stereo cameras 1268 may also be included in a front-facing configuration. In at least one embodiment, one or more of stereo camera(s) 1268 may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the vehicle's environment, including a distance estimate for all the points in the image. An alternative stereo camera(s) 1268 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 1268 may be used in addition to, or alternatively from, those described herein.

Cameras with a field of view that include portions of the environment to the side of the vehicle 1200 (e.g., side-view cameras) may be used for surround view, providing information used to create and update the occupancy grid, as well as to generate side impact collision warnings. For example, surround camera(s) 1274 (e.g., four surround cameras 1274 as illustrated in FIG. 12B) may be positioned to on the vehicle 1200. The surround camera(s) 1274 may include wide-view camera(s) 1270, fisheye camera(s), 360 degree camera(s), and/or the like. Four example, four fisheye cameras may be positioned on the vehicle's front, rear, and sides. In an alternative arrangement, the vehicle may use three surround camera(s) 1274 (e.g., left, right, and rear), and may leverage one or more other camera(s) (e.g., a forward-facing camera) as a fourth surround view camera.

Cameras with a field of view that include portions of the environment to the rear of the vehicle 1200 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 1298, stereo camera(s) 1268), infrared camera(s) 1272, etc.), as described herein.

FIG. 12C is a block diagram of an example system architecture for the example autonomous vehicle 1200 of FIG. 12A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 1200 in FIG. 12C are illustrated as being connected via bus 1202. The bus 1202 may include a Controller Area Network (CAN) data interface (alternatively referred to herein as a “CAN bus”). A CAN may be a network inside the vehicle 1200 used to aid in control of various features and functionality of the vehicle 1200, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 1202 is described herein as being a CAN bus, this is not intended to be limiting. For example, in addition to, or alternatively from, the CAN bus, FlexRay and/or Ethernet may be used. Additionally, although a single line is used to represent the bus 1202, this is not intended to be limiting. For example, there may be any number of busses 1202, which may include one or more CAN busses, one or more FlexRay busses, one or more Ethernet busses, and/or one or more other types of busses using a different protocol. In some examples, two or more busses 1202 may be used to perform different functions, and/or may be used for redundancy. For example, a first bus 1202 may be used for collision avoidance functionality and a second bus 1202 may be used for actuation control. In any example, each bus 1202 may communicate with any of the components of the vehicle 1200, and two or more busses 1202 may communicate with the same components. In some examples, each SoC 1204, each controller 1236, and/or each computer within the vehicle may have access to the same input data (e.g., inputs from sensors of the vehicle 1200), and may be connected to a common bus, such the CAN bus.

The vehicle 1200 may include one or more controller(s) 1236, such as those described herein with respect to FIG. 12A. The controller(s) 1236 may be used for a variety of functions. The controller(s) 1236 may be coupled to any of the various other components and systems of the vehicle 1200, and may be used for control of the vehicle 1200, artificial intelligence of the vehicle 1200, infotainment for the vehicle 1200, and/or the like.

The vehicle 1200 may include a system(s) on a chip (SoC) 1204. The SoC 1204 may include CPU(s) 1206, GPU(s) 1208, processor(s) 1210, cache(s) 1212, accelerator(s) 1214, data store(s) 1216, and/or other components and features not illustrated. The SoC(s) 1204 may be used to control the vehicle 1200 in a variety of platforms and systems. For example, the SoC(s) 1204 may be combined in a system (e.g., the system of the vehicle 1200) with an HD map 1222 which may obtain map refreshes and/or updates via a network interface 1224 from one or more servers (e.g., server(s) 1278 of FIG. 12D).

The CPU(s) 1206 may include a CPU cluster or CPU complex (alternatively referred to herein as a “CCPLEX”). The CPU(s) 1206 may include multiple cores and/or L2 caches. For example, in some embodiments, the CPU(s) 1206 may include eight cores in a coherent multi-processor configuration. In some embodiments, the CPU(s) 1206 may include four dual-core clusters where each cluster has a dedicated L2 cache (e.g., a 2 MB L2 cache). The CPU(s) 1206 (e.g., the CCPLEX) may be configured to support simultaneous cluster operation enabling any combination of the clusters of the CPU(s) 1206 to be active at any given time.

The CPU(s) 1206 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 1206 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 1208 may include an integrated GPU (alternatively referred to herein as an “iGPU”). The GPU(s) 1208 may be programmable and may be efficient for parallel workloads. The GPU(s) 1208, in some examples, may use an enhanced tensor instruction set. The GPU(s) 1208 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 1208 may include at least eight streaming microprocessors. The GPU(s) 1208 may use compute application programming interface(s) (API(s)). In addition, the GPU(s) 1208 may use one or more parallel computing platforms and/or programming models (e.g., NVIDIA's CUDA).

The GPU(s) 1208 may be power-optimized for best performance in automotive and embedded use cases. For example, the GPU(s) 1208 may be fabricated on a Fin field-effect transistor (FinFET). However, this is not intended to be limiting and the GPU(s) 1208 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 1208 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 1208 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 1208 to access the CPU(s) 1206 page tables directly. In such examples, when the GPU(s) 1208 memory management unit (MMU) experiences a miss, an address translation request may be transmitted to the CPU(s) 1206. In response, the CPU(s) 1206 may look in its page tables for the virtual-to-physical mapping for the address and transmits the translation back to the GPU(s) 1208. As such, unified memory technology may allow a single unified virtual address space for memory of both the CPU(s) 1206 and the GPU(s) 1208, thereby simplifying the GPU(s) 1208 programming and porting of applications to the GPU(s) 1208.

In addition, the GPU(s) 1208 may include an access counter that may keep track of the frequency of access of the GPU(s) 1208 to memory of other processors. The access counter may help ensure that memory pages are moved to the physical memory of the processor that is accessing the pages most frequently.

The SoC(s) 1204 may include any number of cache(s) 1212, including those described herein. For example, the cache(s) 1212 may include an L3 cache that is available to both the CPU(s) 1206 and the GPU(s) 1208 (e.g., that is connected both the CPU(s) 1206 and the GPU(s) 1208). The cache(s) 1212 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 1204 may include an arithmetic logic unit(s) (ALU(s)) which may be leveraged in performing processing with respect to any of the variety of tasks or operations of the vehicle 1200—such as processing DNNs. In addition, the SoC(s) 1204 may include a floating point unit(s) (FPU(s))—or other math coprocessor or numeric coprocessor types—for performing mathematical operations within the system. For example, the SoC(s) 104 may include one or more FPUs integrated as execution units within a CPU(s) 1206 and/or GPU(s) 1208.

The SoC(s) 1204 may include one or more accelerators 1214 (e.g., hardware accelerators, software accelerators, or a combination thereof). For example, the SoC(s) 1204 may include a hardware acceleration cluster that may include optimized hardware accelerators and/or large on-chip memory. The large on-chip memory (e.g., 4 MB of SRAM), may enable the hardware acceleration cluster to accelerate neural networks and other calculations. The hardware acceleration cluster may be used to complement the GPU(s) 1208 and to off-load some of the tasks of the GPU(s) 1208 (e.g., to free up more cycles of the GPU(s) 1208 for performing other tasks). As an example, the accelerator(s) 1214 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 1214 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 1208, and by using an inference accelerator, for example, a designer may target either the DLA(s) or the GPU(s) 1208 for any function. For example, the designer may focus processing of CNNs and floating point operations on the DLA(s) and leave other functions to the GPU(s) 1208 and/or other accelerator(s) 1214.

The accelerator(s) 1214 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 1206. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 1214 (e.g., the hardware acceleration cluster) may include a computer vision network on-chip and SRAM, for providing a high-bandwidth, low latency SRAM for the accelerator(s) 1214. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 1204 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LIDAR data for purposes of localization and/or other functions, and/or for other uses. In some embodiments, one or more tree traversal units (TTUs) may be used for executing one or more ray-tracing related operations.

The accelerator(s) 1214 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 1266 output that correlates with the vehicle 1200 orientation, distance, 3D location estimates of the object obtained from the neural network and/or other sensors (e.g., LIDAR sensor(s) 1264 or RADAR sensor(s) 1260), among others.

The SoC(s) 1204 may include data store(s) 1216 (e.g., memory). The data store(s) 1216 may be on-chip memory of the SoC(s) 1204, which may store neural networks to be executed on the GPU and/or the DLA. In some examples, the data store(s) 1216 may be large enough in capacity to store multiple instances of neural networks for redundancy and safety. The data store(s) 1212 may comprise L2 or L3 cache(s) 1212. Reference to the data store(s) 1216 may include reference to the memory associated with the PVA, DLA, and/or other accelerator(s) 1214, as described herein.

The SoC(s) 1204 may include one or more processor(s) 1210 (e.g., embedded processors). The processor(s) 1210 may include a boot and power management processor that may be a dedicated processor and subsystem to handle boot power and management functions and related security enforcement. The boot and power management processor may be a part of the SoC(s) 1204 boot sequence and may provide runtime power management services. The boot power and management processor may provide clock and voltage programming, assistance in system low power state transitions, management of SoC(s) 1204 thermals and temperature sensors, and/or management of the SoC(s) 1204 power states. Each temperature sensor may be implemented as a ring-oscillator whose output frequency is proportional to temperature, and the SoC(s) 1204 may use the ring-oscillators to detect temperatures of the CPU(s) 1206, GPU(s) 1208, and/or accelerator(s) 1214. If temperatures are determined to exceed a threshold, the boot and power management processor may enter a temperature fault routine and put the SoC(s) 1204 into a lower power state and/or put the vehicle 1200 into a chauffeur to safe stop mode (e.g., bring the vehicle 1200 to a safe stop).

The processor(s) 1210 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 1210 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 1210 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 1210 may further include a real-time camera engine that may include a dedicated processor subsystem for handling real-time camera management.

The processor(s) 1210 may further include a high-dynamic range signal processor that may include an image signal processor that is a hardware engine that is part of the camera processing pipeline.

The processor(s) 1210 may include a video image compositor that may be a processing block (e.g., implemented on a microprocessor) that implements video post-processing functions needed by a video playback application to produce the final image for the player window. The video image compositor may perform lens distortion correction on wide-view camera(s) 1270, surround camera(s) 1274, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 1208 is not required to continuously render new surfaces. Even when the GPU(s) 1208 is powered on and active doing 3D rendering, the video image compositor may be used to offload the GPU(s) 1208 to improve performance and responsiveness.

The SoC(s) 1204 may further include a mobile industry processor interface (MIPI) camera serial interface for receiving video and input from cameras, a high-speed interface, and/or a video input block that may be used for camera and related pixel input functions. The SoC(s) 1204 may further include an input/output controller(s) that may be controlled by software and may be used for receiving I/O signals that are uncommitted to a specific role.

The SoC(s) 1204 may further include a broad range of peripheral interfaces to enable communication with peripherals, audio codecs, power management, and/or other devices. The SoC(s) 1204 may be used to process data from cameras (e.g., connected over Gigabit Multimedia Serial Link and Ethernet), sensors (e.g., LIDAR sensor(s) 1264, RADAR sensor(s) 1260, etc. that may be connected over Ethernet), data from bus 1202 (e.g., speed of vehicle 1200, steering wheel position, etc.), data from GNSS sensor(s) 1258 (e.g., connected over Ethernet or CAN bus). The SoC(s) 1204 may further include dedicated high-performance mass storage controllers that may include their own DMA engines, and that may be used to free the CPU(s) 1206 from routine data management tasks.

The SoC(s) 1204 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 1204 may be faster, more reliable, and even more energy-efficient and space-efficient than conventional systems. For example, the accelerator(s) 1214, when combined with the CPU(s) 1206, the GPU(s) 1208, and the data store(s) 1216, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 1220) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 1208.

In some examples, a CNN for facial recognition and vehicle owner identification may use data from camera sensors to identify the presence of an authorized driver and/or owner of the vehicle 1200. The always on sensor processing engine may be used to unlock the vehicle when the owner approaches the driver door and turn on the lights, and, in security mode, to disable the vehicle when the owner leaves the vehicle. In this way, the SoC(s) 1204 provide for security against theft and/or carjacking.

In another example, a CNN for emergency vehicle detection and identification may use data from microphones 1296 to detect and identify emergency vehicle sirens. In contrast to conventional systems, that use general classifiers to detect sirens and manually extract features, the SoC(s) 1204 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 1258. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 1262, until the emergency vehicle(s) passes.

The vehicle may include a CPU(s) 1218 (e.g., discrete CPU(s), or dCPU(s)), that may be coupled to the SoC(s) 1204 via a high-speed interconnect (e.g., PCIe). The CPU(s) 1218 may include an X86 processor, for example. The CPU(s) 1218 may be used to perform any of a variety of functions, including arbitrating potentially inconsistent results between ADAS sensors and the SoC(s) 1204, and/or monitoring the status and health of the controller(s) 1236 and/or infotainment SoC 1230, for example.

The vehicle 1200 may include a GPU(s) 1220 (e.g., discrete GPU(s), or dGPU(s)), that may be coupled to the SoC(s) 1204 via a high-speed interconnect (e.g., NVIDIA's NVLINK). The GPU(s) 1220 may provide additional artificial intelligence functionality, such as by executing redundant and/or different neural networks, and may be used to train and/or update neural networks based on input (e.g., sensor data) from sensors of the vehicle 1200.

The vehicle 1200 may further include the network interface 1224 which may include one or more wireless antennas 1226 (e.g., one or more wireless antennas for different communication protocols, such as a cellular antenna, a Bluetooth antenna, etc.). The network interface 1224 may be used to enable wireless connectivity over the Internet with the cloud (e.g., with the server(s) 1278 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 1200 information about vehicles in proximity to the vehicle 1200 (e.g., vehicles in front of, on the side of, and/or behind the vehicle 1200). This functionality may be part of a cooperative adaptive cruise control functionality of the vehicle 1200.

The network interface 1224 may include a SoC that provides modulation and demodulation functionality and enables the controller(s) 1236 to communicate over wireless networks. The network interface 1224 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 1200 may further include data store(s) 1228 which may include off-chip (e.g., off the SoC(s) 1204) storage. The data store(s) 1228 may include one or more storage elements including RAM, SRAM, DRAM, VRAM, Flash, hard disks, and/or other components and/or devices that may store at least one bit of data.

The vehicle 1200 may further include GNSS sensor(s) 1258. The GNSS sensor(s) 1258 (e.g., GPS, assisted GPS sensors, differential GPS (DGPS) sensors, etc.), to assist in mapping, perception, occupancy grid generation, and/or path planning functions. Any number of GNSS sensor(s) 1258 may be used, including, for example and without limitation, a GPS using a USB connector with an Ethernet to Serial (RS-232) bridge.

The vehicle 1200 may further include RADAR sensor(s) 1260. The RADAR sensor(s) 1260 may be used by the vehicle 1200 for long-range vehicle detection, even in darkness and/or severe weather conditions. RADAR functional safety levels may be ASIL B. The RADAR sensor(s) 1260 may use the CAN and/or the bus 1202 (e.g., to transmit data generated by the RADAR sensor(s) 1260) for control and to access object tracking data, with access to Ethernet to access raw data in some examples. A wide variety of RADAR sensor types may be used. For example, and without limitation, the RADAR sensor(s) 1260 may be suitable for front, rear, and side RADAR use. In some example, Pulse Doppler RADAR sensor(s) are used.

The RADAR sensor(s) 1260 may include different configurations, such as long range with narrow field of view, short range with wide field of view, short range side coverage, etc. In some examples, long-range RADAR may be used for adaptive cruise control functionality. The long-range RADAR systems may provide a broad field of view realized by two or more independent scans, such as within a 250 m range. The RADAR sensor(s) 1260 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 1200 surroundings at higher speeds with minimal interference from traffic in adjacent lanes. The other two antennae may expand the field of view, making it possible to quickly detect vehicles entering or leaving the vehicle's 1200 lane.

Mid-range RADAR systems may include, as an example, a range of up to 1260 m (front) or 80 m (rear), and a field of view of up to 42 degrees (front) or 1250 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 1200 may further include ultrasonic sensor(s) 1262. The ultrasonic sensor(s) 1262, which may be positioned at the front, back, and/or the sides of the vehicle 1200, may be used for park assist and/or to create and update an occupancy grid. A wide variety of ultrasonic sensor(s) 1262 may be used, and different ultrasonic sensor(s) 1262 may be used for different ranges of detection (e.g., 2.5 m, 4 m). The ultrasonic sensor(s) 1262 may operate at functional safety levels of ASIL B.

The vehicle 1200 may include LIDAR sensor(s) 1264. The LIDAR sensor(s) 1264 may be used for object and pedestrian detection, emergency braking, collision avoidance, and/or other functions. The LIDAR sensor(s) 1264 may be functional safety level ASIL B. In some examples, the vehicle 1200 may include multiple LIDAR sensors 1264 (e.g., two, four, six, etc.) that may use Ethernet (e.g., to provide data to a Gigabit Ethernet switch).

In some examples, the LIDAR sensor(s) 1264 may be capable of providing a list of objects and their distances for a 360-degree field of view. Commercially available LIDAR sensor(s) 1264 may have an advertised range of approximately 1200 m, with an accuracy of 2 cm-3 cm, and with support for a 1200 Mbps Ethernet connection, for example. In some examples, one or more non-protruding LIDAR sensors 1264 may be used. In such examples, the LIDAR sensor(s) 1264 may be implemented as a small device that may be embedded into the front, rear, sides, and/or corners of the vehicle 1200. The LIDAR sensor(s) 1264, in such examples, may provide up to a 120-degree horizontal and 35-degree vertical field-of-view, with a 200 m range even for low-reflectivity objects. Front-mounted LIDAR sensor(s) 1264 may be configured for a horizontal field of view between 45 degrees and 135 degrees.

In some examples, LIDAR technologies, such as 3D flash LIDAR, may also be used. 3D Flash LIDAR uses a flash of a laser as a transmission source, to illuminate vehicle surroundings up to approximately 200 m. A flash LIDAR unit includes a receptor, which records the laser pulse transit time and the reflected light on each pixel, which in turn corresponds to the range from the vehicle to the objects. Flash LIDAR may allow for highly accurate and distortion-free images of the surroundings to be generated with every laser flash. In some examples, four flash LIDAR sensors may be deployed, one at each side of the vehicle 1200. Available 3D flash LIDAR systems include a solid-state 3D staring array LIDAR camera with no moving parts other than a fan (e.g., a non-scanning LIDAR device). The flash LIDAR device may use a 5 nanosecond class I (eye-safe) laser pulse per frame and may capture the reflected laser light in the form of 3D range point clouds and co-registered intensity data. By using flash LIDAR, and because flash LIDAR is a solid-state device with no moving parts, the LIDAR sensor(s) 1264 may be less susceptible to motion blur, vibration, and/or shock.

The vehicle may further include IMU sensor(s) 1266. The IMU sensor(s) 1266 may be located at a center of the rear axle of the vehicle 1200, in some examples. The IMU sensor(s) 1266 may include, for example and without limitation, an accelerometer(s), a magnetometer(s), a gyroscope(s), a magnetic compass(es), and/or other sensor types. In some examples, such as in six-axis applications, the IMU sensor(s) 1266 may include accelerometers and gyroscopes, while in nine-axis applications, the IMU sensor(s) 1266 may include accelerometers, gyroscopes, and magnetometers.

In some embodiments, the IMU sensor(s) 1266 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 1266 may enable the vehicle 1200 to estimate heading without requiring input from a magnetic sensor by directly observing and correlating the changes in velocity from GPS to the IMU sensor(s) 1266. In some examples, the IMU sensor(s) 1266 and the GNSS sensor(s) 1258 may be combined in a single integrated unit.

The vehicle may include microphone(s) 1296 placed in and/or around the vehicle 1200. The microphone(s) 1296 may be used for emergency vehicle detection and identification, among other things.

The vehicle may further include any number of camera types, including stereo camera(s) 1268, wide-view camera(s) 1270, infrared camera(s) 1272, surround camera(s) 1274, long-range and/or mid-range camera(s) 1298, and/or other camera types. The cameras may be used to capture image data around an entire periphery of the vehicle 1200. The types of cameras used depends on the embodiments and requirements for the vehicle 1200, and any combination of camera types may be used to provide the necessary coverage around the vehicle 1200. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 12A and FIG. 12B.

The vehicle 1200 may further include vibration sensor(s) 1242. The vibration sensor(s) 1242 may measure vibrations of components of the vehicle, such as the axle(s). For example, changes in vibrations may indicate a change in road surfaces. In another example, when two or more vibration sensors 1242 are used, the differences between the vibrations may be used to determine friction or slippage of the road surface (e.g., when the difference in vibration is between a power-driven axle and a freely rotating axle).

The vehicle 1200 may include an ADAS system 1238. The ADAS system 1238 may include a SoC, in some examples. The ADAS system 1238 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 1260, LIDAR sensor(s) 1264, and/or a camera(s). The ACC systems may include longitudinal ACC and/or lateral ACC. Longitudinal ACC monitors and controls the distance to the vehicle immediately ahead of the vehicle 1200 and automatically adjust the vehicle speed to maintain a safe distance from vehicles ahead. Lateral ACC performs distance keeping, and advises the vehicle 1200 to change lanes when necessary. Lateral ACC is related to other ADAS applications such as LCA and CWS.

CACC uses information from other vehicles that may be received via the network interface 1224 and/or the wireless antenna(s) 1226 from other vehicles via a wireless link, or indirectly, over a network connection (e.g., over the Internet). Direct links may be provided by a vehicle-to-vehicle (V2V) communication link, while indirect links may be infrastructure-to-vehicle (I2V) communication link. In general, the V2V communication concept provides information about the immediately preceding vehicles (e.g., vehicles immediately ahead of and in the same lane as the vehicle 1200), while the I2V communication concept provides information about traffic further ahead. CACC systems may include either or both I2V and V2V information sources. Given the information of the vehicles ahead of the vehicle 1200, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 1260, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 1260, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 1200 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 1200 if the vehicle 1200 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 1260, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 1200 is backing up. Some RCTW systems include AEB to ensure that the vehicle brakes are applied to avoid a crash. RCTW systems may use one or more rear-facing RADAR sensor(s) 1260, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 1200, the vehicle 1200 itself must, in the case of conflicting results, decide whether to heed the result from a primary computer or a secondary computer (e.g., a first controller 1236 or a second controller 1236). For example, in some embodiments, the ADAS system 1238 may be a backup and/or secondary computer for providing perception information to a backup computer rationality module. The backup computer rationality monitor may run a redundant diverse software on hardware components to detect faults in perception and dynamic driving tasks. Outputs from the ADAS system 1238 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 1204.

In other examples, ADAS system 1238 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 1238 may be fed into the primary computer's perception block and/or the primary computer's dynamic driving task block. For example, if the ADAS system 1238 indicates a forward crash warning due to an object immediately ahead, the perception block may use this information when identifying objects. In other examples, the secondary computer may have its own neural network which is trained and thus reduces the risk of false positives, as described herein.

The vehicle 1200 may further include the infotainment SoC 1230 (e.g., an in-vehicle infotainment system (IVI)). Although illustrated and described as a SoC, the infotainment system may not be a SoC, and may include two or more discrete components. The infotainment SoC 1230 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 1200. For example, the infotainment SoC 1230 may radios, disk players, navigation systems, video players, USB and Bluetooth connectivity, carputers, in-car entertainment, Wi-Fi, steering wheel audio controls, hands free voice control, a heads-up display (HUD), an HMI display 1234, a telematics device, a control panel (e.g., for controlling and/or interacting with various components, features, and/or systems), and/or other components. The infotainment SoC 1230 may further be used to provide information (e.g., visual and/or audible) to a user(s) of the vehicle, such as information from the ADAS system 1238, autonomous driving information such as planned vehicle maneuvers, trajectories, surrounding environment information (e.g., intersection information, vehicle information, road information, etc.), and/or other information.

The infotainment SoC 1230 may include GPU functionality. The infotainment SoC 1230 may communicate over the bus 1202 (e.g., CAN bus, Ethernet, etc.) with other devices, systems, and/or components of the vehicle 1200. In some examples, the infotainment SoC 1230 may be coupled to a supervisory MCU such that the GPU of the infotainment system may perform some self-driving functions in the event that the primary controller(s) 1236 (e.g., the primary and/or backup computers of the vehicle 1200) fail. In such an example, the infotainment SoC 1230 may put the vehicle 1200 into a chauffeur to safe stop mode, as described herein.

The vehicle 1200 may further include an instrument cluster 1232 (e.g., a digital dash, an electronic instrument cluster, a digital instrument panel, etc.). The instrument cluster 1232 may include a controller and/or supercomputer (e.g., a discrete controller or supercomputer). The instrument cluster 1232 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 1230 and the instrument cluster 1232. In other words, the instrument cluster 1232 may be included as part of the infotainment SoC 1230, or vice versa.

FIG. 12D is a system diagram for communication between cloud-based server(s) and the example autonomous vehicle 1200 of FIG. 12A, in accordance with some embodiments of the present disclosure. The system 1276 may include server(s) 1278, network(s) 1290, and vehicles, including the vehicle 1200. The server(s) 1278 may include a plurality of GPUs 1284(A)-1284(H) (collectively referred to herein as GPUs 1284), PCIe switches 1282(A)-1282(H) (collectively referred to herein as PCIe switches 1282), and/or CPUs 1280(A)-1280(B) (collectively referred to herein as CPUs 1280). The GPUs 1284, the CPUs 1280, and the PCIe switches may be interconnected with high-speed interconnects such as, for example and without limitation, NVLink interfaces 1288 developed by NVIDIA and/or PCIe connections 1286. In some examples, the GPUs 1284 are connected via NVLink and/or NVSwitch SoC and the GPUs 1284 and the PCIe switches 1282 are connected via PCIe interconnects. Although eight GPUs 1284, two CPUs 1280, and two PCIe switches are illustrated, this is not intended to be limiting. Depending on the embodiment, each of the server(s) 1278 may include any number of GPUs 1284, CPUs 1280, and/or PCIe switches. For example, the server(s) 1278 may each include eight, sixteen, thirty-two, and/or more GPUs 1284.

The server(s) 1278 may receive, over the network(s) 1290 and from the vehicles, image data representative of images showing unexpected or changed road conditions, such as recently commenced road-work. The server(s) 1278 may transmit, over the network(s) 1290 and to the vehicles, neural networks 1292, updated neural networks 1292, and/or map information 1294, including information regarding traffic and road conditions. The updates to the map information 1294 may include updates for the HD map 1222, such as information regarding construction sites, potholes, detours, flooding, and/or other obstructions. In some examples, the neural networks 1292, the updated neural networks 1292, and/or the map information 1294 may have resulted from new training and/or experiences represented in data received from any number of vehicles in the environment, and/or based on training performed at a datacenter (e.g., using the server(s) 1278 and/or other servers).

The server(s) 1278 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 1290, and/or the machine learning models may be used by the server(s) 1278 to remotely monitor the vehicles.

In some examples, the server(s) 1278 may receive data from the vehicles and apply the data to up-to-date real-time neural networks for real-time intelligent inferencing. The server(s) 1278 may include deep-learning supercomputers and/or dedicated AI computers powered by GPU(s) 1284, such as a DGX and DGX Station machines developed by NVIDIA. However, in some examples, the server(s) 1278 may include deep learning infrastructure that use only CPU-powered datacenters.

The deep-learning infrastructure of the server(s) 1278 may be capable of fast, real-time inferencing, and may use that capability to evaluate and verify the health of the processors, software, and/or associated hardware in the vehicle 1200. For example, the deep-learning infrastructure may receive periodic updates from the vehicle 1200, such as a sequence of images and/or objects that the vehicle 1200 has located in that sequence of images (e.g., via computer vision and/or other machine learning object classification techniques). The deep-learning infrastructure may run its own neural network to identify the objects and compare them with the objects identified by the vehicle 1200 and, if the results do not match and the infrastructure concludes that the AI in the vehicle 1200 is malfunctioning, the server(s) 1278 may transmit a signal to the vehicle 1200 instructing a fail-safe computer of the vehicle 1200 to assume control, notify the passengers, and complete a safe parking maneuver.

For inferencing, the server(s) 1278 may include the GPU(s) 1284 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

Example Computing Device

FIG. 13 is a block diagram of an example computing device(s) 1300 suitable for use in implementing some embodiments of the present disclosure. Computing device 1300 may include an interconnect system 1302 that directly or indirectly couples the following devices: memory 1304, one or more central processing units (CPUs) 1306, one or more graphics processing units (GPUs) 1308, a communication interface 1310, input/output (I/O) ports 1312, input/output components 1314, a power supply 1316, one or more presentation components 1318 (e.g., display(s)), and one or more logic units 1320. In at least one embodiment, the computing device(s) 1300 may comprise one or more virtual machines (VMs), and/or any of the components thereof may comprise virtual components (e.g., virtual hardware components). For non-limiting examples, one or more of the GPUs 1308 may comprise one or more vGPUs, one or more of the CPUs 1306 may comprise one or more vCPUs, and/or one or more of the logic units 1320 may comprise one or more virtual logic units. As such, a computing device(s) 1300 may include discrete components (e.g., a full GPU dedicated to the computing device 1300), virtual components (e.g., a portion of a GPU dedicated to the computing device 1300), or a combination thereof.

Although the various blocks of FIG. 13 are shown as connected via the interconnect system 1302 with lines, this is not intended to be limiting and is for clarity only. For example, in some embodiments, a presentation component 1318, such as a display device, may be considered an I/O component 1314 (e.g., if the display is a touch screen). As another example, the CPUs 1306 and/or GPUs 1308 may include memory (e.g., the memory 1304 may be representative of a storage device in addition to the memory of the GPUs 1308, the CPUs 1306, and/or other components). In other words, the computing device of FIG. 13 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 13.

The interconnect system 1302 may represent one or more links or busses, such as an address bus, a data bus, a control bus, or a combination thereof. The interconnect system 1302 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1306 may be directly connected to the memory 1304. Further, the CPU 1306 may be directly connected to the GPU 1308. Where there is direct, or point-to-point connection between components, the interconnect system 1302 may include a PCIe link to carry out the connection. In these examples, a PCI bus need not be included in the computing device 1300.

The memory 1304 may include any of a variety of computer-readable media. The computer-readable media may be any available media that may be accessed by the computing device 1300. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1304 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1300. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1306 may be configured to execute at least some of the computer-readable instructions to control one or more components of the computing device 1300 to perform one or more of the methods and/or processes described herein. The CPU(s) 1306 may each include one or more cores (e.g., one, two, four, eight, twenty-eight, seventy-two, etc.) that are capable of handling a multitude of software threads simultaneously. The CPU(s) 1306 may include any type of processor, and may include different types of processors depending on the type of computing device 1300 implemented (e.g., processors with fewer cores for mobile devices and processors with more cores for servers). For example, depending on the type of computing device 1300, the processor may be an Advanced RISC Machines (ARM) processor implemented using Reduced Instruction Set Computing (RISC) or an x86 processor implemented using Complex Instruction Set Computing (CISC). The computing device 1300 may include one or more CPUs 1306 in addition to one or more microprocessors or supplementary co-processors, such as math co-processors.

In addition to or alternatively from the CPU(s) 1306, the GPU(s) 1308 may be configured to execute at least some of the computer-readable instructions to control one or more components of the computing device 1300 to perform one or more of the methods and/or processes described herein. One or more of the GPU(s) 1308 may be an integrated GPU (e.g., with one or more of the CPU(s) 1306 and/or one or more of the GPU(s) 1308 may be a discrete GPU. In embodiments, one or more of the GPU(s) 1308 may be a coprocessor of one or more of the CPU(s) 1306. The GPU(s) 1308 may be used by the computing device 1300 to render graphics (e.g., 3D graphics) or perform general purpose computations. For example, the GPU(s) 1308 may be used for General-Purpose computing on GPUs (GPGPU). The GPU(s) 1308 may include hundreds or thousands of cores that are capable of handling hundreds or thousands of software threads simultaneously. The GPU(s) 1308 may generate pixel data for output images in response to rendering commands (e.g., rendering commands from the CPU(s) 1306 received via a host interface). The GPU(s) 1308 may include graphics memory, such as display memory, for storing pixel data or any other suitable data, such as GPGPU data. The display memory may be included as part of the memory 1304. The GPU(s) 1308 may include two or more GPUs operating in parallel (e.g., via a link). The link may directly connect the GPUs (e.g., using NVLINK) or may connect the GPUs through a switch (e.g., using NVSwitch). When combined together, each GPU 1308 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1306 and/or the GPU(s) 1308, the logic unit(s) 1320 may be configured to execute at least some of the computer-readable instructions to control one or more components of the computing device 1300 to perform one or more of the methods and/or processes described herein. In embodiments, the CPU(s) 1306, the GPU(s) 1308, and/or the logic unit(s) 1320 may discretely or jointly perform any combination of the methods, processes and/or portions thereof. One or more of the logic units 1320 may be part of and/or integrated in one or more of the CPU(s) 1306 and/or the GPU(s) 1308 and/or one or more of the logic units 1320 may be discrete components or otherwise external to the CPU(s) 1306 and/or the GPU(s) 1308. In embodiments, one or more of the logic units 1320 may be a coprocessor of one or more of the CPU(s) 1306 and/or one or more of the GPU(s) 1308.

Examples of the logic unit(s) 1320 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1310 may include one or more receivers, transmitters, and/or transceivers that enable the computing device 1300 to communicate with other computing devices via an electronic communication network, included wired and/or wireless communications. The communication interface 1310 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1320 and/or communication interface 1310 may include one or more data processing units (DPUs) to transmit data received over a network and/or through interconnect system 1302 directly to (e.g., a memory of) one or more GPU(s) 1308.

The I/O ports 1312 may enable the computing device 1300 to be logically coupled to other devices including the I/O components 1314, the presentation component(s) 1318, and/or other components, some of which may be built in to (e.g., integrated in) the computing device 1300. Illustrative I/O components 1314 include a microphone, mouse, keyboard, joystick, game pad, game controller, satellite dish, scanner, printer, wireless device, etc. The I/O components 1314 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1300. The computing device 1300 may be include depth cameras, such as stereoscopic camera systems, infrared camera systems, RGB camera systems, touchscreen technology, and combinations of these, for gesture detection and recognition. Additionally, the computing device 1300 may include accelerometers or gyroscopes (e.g., as part of an inertia measurement unit (IMU)) that enable detection of motion. In some examples, the output of the accelerometers or gyroscopes may be used by the computing device 1300 to render immersive augmented reality or virtual reality.

The power supply 1316 may include a hard-wired power supply, a battery power supply, or a combination thereof. The power supply 1316 may provide power to the computing device 1300 to enable the components of the computing device 1300 to operate.

The presentation component(s) 1318 may include a display (e.g., a monitor, a touch screen, a television screen, a heads-up-display (HUD), other display types, or a combination thereof), speakers, and/or other presentation components. The presentation component(s) 1318 may receive data from other components (e.g., the GPU(s) 1308, the CPU(s) 1306, DPUs, etc.), and output the data (e.g., as an image, video, sound, etc.).

Example Data Center

FIG. 14 illustrates an example data center 1400 that may be used in at least one embodiments of the present disclosure. The data center 1400 may include a data center infrastructure layer 1410, a framework layer 1420, a software layer 1430, and/or an application layer 1440.

As shown in FIG. 14, the data center infrastructure layer 1410 may include a resource orchestrator 1412, grouped computing resources 1414, and node computing resources (“node C.R.s”) 1416(1)-1416(N), where “N” represents any whole, positive integer. In at least one embodiment, node C.R.s 1416(1)-1416(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1416(1)-1416(N) may correspond to a server having one or more of the above-mentioned computing resources. In addition, in some embodiments, the node C.R.s 1416(1)-14161(N) may include one or more virtual components, such as vGPUs, vCPUs, and/or the like, and/or one or more of the node C.R.s 1416(1)-1416(N) may correspond to a virtual machine (VM).

In at least one embodiment, grouped computing resources 1414 may include separate groupings of node C.R.s 1416 housed within one or more racks (not shown), or many racks housed in data centers at various geographical locations (also not shown). Separate groupings of node C.R.s 1416 within grouped computing resources 1414 may include grouped compute, network, memory or storage resources that may be configured or allocated to support one or more workloads. In at least one embodiment, several node C.R.s 1416 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1412 may configure or otherwise control one or more node C.R.s 1416(1)-1416(N) and/or grouped computing resources 1414. In at least one embodiment, resource orchestrator 1412 may include a software design infrastructure (SDI) management entity for the data center 1400. The resource orchestrator 1412 may include hardware, software, or some combination thereof.

In at least one embodiment, as shown in FIG. 14, framework layer 1420 may include a job scheduler 1433, a configuration manager 1434, a resource manager 1436, and/or a distributed file system 1438. The framework layer 1420 may include a framework to support software 1432 of software layer 1430 and/or one or more application(s) 1442 of application layer 1440. The software 1432 or application(s) 1442 may respectively include web-based service software or applications, such as those provided by Amazon Web Services, Google Cloud and Microsoft Azure. The framework layer 1420 may be, but is not limited to, a type of free and open-source software web application framework such as Apache Spark™ (hereinafter “Spark”) that may utilize distributed file system 1438 for large-scale data processing (e.g., “big data”). In at least one embodiment, job scheduler 1433 may include a Spark driver to facilitate scheduling of workloads supported by various layers of data center 1400. The configuration manager 1434 may be capable of configuring different layers such as software layer 1430 and framework layer 1420 including Spark and distributed file system 1438 for supporting large-scale data processing. The resource manager 1436 may be capable of managing clustered or grouped computing resources mapped to or allocated for support of distributed file system 1438 and job scheduler 1433. In at least one embodiment, clustered or grouped computing resources may include grouped computing resource 1414 at data center infrastructure layer 1410. The resource manager 1436 may coordinate with resource orchestrator 1412 to manage these mapped or allocated computing resources.

In at least one embodiment, software 1432 included in software layer 1430 may include software used by at least portions of node C.R.s 1416(1)-1416(N), grouped computing resources 1414, and/or distributed file system 1438 of framework layer 1420. One or more types of software may include, but are not limited to, Internet web page search software, e-mail virus scan software, database software, and streaming video content software.

In at least one embodiment, application(s) 1442 included in application layer 1440 may include one or more types of applications used by at least portions of node C.R.s 1416(1)-1416(N), grouped computing resources 1414, and/or distributed file system 1438 of framework layer 1420. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1434, resource manager 1436, and resource orchestrator 1412 may implement any number and type of self-modifying actions based on any amount and type of data acquired in any technically feasible fashion. Self-modifying actions may relieve a data center operator of data center 1400 from making possibly bad configuration decisions and possibly avoiding underutilized and/or poor performing portions of a data center.

The data center 1400 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1400. In at least one embodiment, trained or deployed machine learning models corresponding to one or more neural networks may be used to infer or predict information using resources described above with respect to the data center 1400 by using weight parameters calculated through one or more training techniques, such as but not limited to those described herein.

In at least one embodiment, the data center 1400 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1300 of FIG. 13—e.g., each device may include similar components, features, and/or functionality of the computing device(s) 1300. In addition, where backend devices (e.g., servers, NAS, etc.) are implemented, the backend devices may be included as part of a data center 1400, an example of which is described in more detail herein with respect to FIG. 14.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1300 described herein with respect to FIG. 13. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A method comprising:
determining, using one or more first machine learning models and based at least on audio data representing speech, an intent associated with the speech;
determining, based at least on image data representing an image depicting a user, a point of interest (POI) associated with the user; and
determining, using one or more second machine learning models and based at least on the intent and the POI, an output associated with the speech.

2. The method of claim 1, further comprising:
determining, based at least on the POI, a context associated with the intent,
wherein the determining of the output associated with the speech is based at least on the intent and the context.

3. The method of claim 2, wherein the determining the context associated with the intent comprises determining, based at least on the POI, an identifier associated with a landmark, the context including at least the identifier associated with the landmark.

4. The method of claim 1, further comprising:
determining at least one of a geographic area associated with the user or a time period,
wherein the determining of the output associated with the speech is further based at least on the at least one of the geographic area or the time period.

5. The method of claim 1, further comprising:
receiving second image data representing an image depicting an environment,
wherein the determining of the POI associated with the user is further based least on the second image data.

6. The method of claim 1, further comprising:
determining, using the one or more first machine learning models and based at least on the audio data, one or more parameters for one or more slots associated with the intent,
wherein the determining of the output associated with the speech is further based at least on the one or more parameters.

7. The method of claim 1, wherein the determining the POI associated with the user comprises:
determining, based at least on the image data, a gaze direction associated with the user; and
determining, based at least on the gaze direction and map data representing an environment, the POI associated with the user.

8. The method of claim 1, wherein the determining the POI associated with the user comprises:
determining, based at least on the image data, a gesture direction associated with the user; and
determining, based at least on the gesture direction and map data representing an environment, the POI associated with the user.

9. The method of claim 1, wherein the determining of the POI associated with the user comprises:
determining, based at least on the image data and first data representing an environment, a first POI associated with the user
determining, based at least on the image data and second data representing the environment, a second POI associated with the user; and
determining, based at least on the first POI and the second POI, the POI associated with the user.

10. The method of claim 1, wherein the output associated with the speech comprises at least one of:
audio data representing one or more words that provide information associated with the intent; or
content data representing one or more images depicting content associated with the intent.

11. A system comprising:
one or more processing units to:
receive audio data representing speech;
determine, based at least on image data representing an image depicting a user and map data representing an environment in which the user is located, a point of interest (POI) associated with the user; and
determine, using one or more machine learning models and based at least on the audio data and the POI, an output associated with the speech.

12. The system of claim 11, wherein the one or more processing units are further to:
determine, based at least on the POI, a context associated with the audio data,
wherein the determination of the output associated with the speech is based at least on the audio data and the context.

13. The system of claim 12, wherein the one or more processing units are further to:
determine, using one or more second machine learning models and based at least on the audio data, an intent associated with the speech;
append the context to the intent; and
apply, as an input to the one or more machine learning models, the context appended to the intent.

14. The system of claim 11, wherein the one or more processing units are further to:
determine, using one or more second machine learning models and based at least on the audio data, at least one of an intent associated with the speech or one or more parameters for one or more slots associated with the intent;
wherein the determination of the output associated with the speech is based at least on the at least one of the intent or the one or more parameters.

15. The system of claim 11, wherein the one or more processing units are to determine the POI associated by:
determining, based at least on the image data, at least one of a gaze direction or a gesture direction associated with the user; and
determining, based at least on the at least one of gaze direction or the gesture direction and the map data, the POI associated with the user.

16. The system of claim 11, wherein the one or more processing units are further to:
determine at least one of a geographic area associated with the environment or a time period,
wherein the determination of the output associated with the speech is further based at least on the at least one of the geographic area or the time period.

17. The system of claim 11, wherein the system is comprised in at least one of:
a control system for an autonomous or semi-autonomous machine;
a perception system for an autonomous or semi-autonomous machine;
a system for performing simulation operations;
a system for presenting virtual reality (VR) content;
a system for presenting augmented reality (AR) content;
a system for presenting mixed reality (MR) content;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for generating synthetic data;
a system incorporating one or more virtual machines (VMs);
a system implemented at least partially in a data center; or
a system implemented at least partially using cloud computing resources.

18. A processor comprising:
one or more processing units to determine, using one or more machine learning models, an output associated with speech based at least on an intent associated with the speech and a context associated with the intent, the context determined using a point of interest (POI) associated with a user.

19. The processor of claim 18, wherein the determination of the POI comprises:
determining, based at least on image data representing an image depicting the user, at least one of a gaze direction or a gesture direction associated with the user; and
determining, based at least on the at least one of gaze direction or the gesture direction, the POI associated with the user.

20. The processor of claim 18, wherein the processor is comprised in at least one of:
a control system for an autonomous or semi-autonomous machine;
a perception system for an autonomous or semi-autonomous machine;
a system for performing simulation operations;
a system for presenting virtual reality (VR) content;
a system for presenting augmented reality (AR) content;
a system for presenting mixed reality (MR) content;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for generating synthetic data;
a system incorporating one or more virtual machines (VMs);
a system implemented at least partially in a data center; or
a system implemented at least partially using cloud computing resources.
